(19) United States
(12) Patent Application Publication
(10) Pub. No.: US 2026/0067812 A1
(43) Pub. Date: Mar. 5, 2026

(54) SYSTEMS, APPARATUSES, METHODS, AND NON-TRANSITORY COMPUTER-READABLE STORAGE DEVICES FOR WIRELESS COMMUNICATION EMPLOYING ENERGY-STATE REPORTING METHODS FOR AMBIENT-POWER WIRELESS LOCAL AREA NETWORK (WLAN) DEVICES

(71) Applicant: HUAWEI TECHNOLOGIES CO., LTD., Shenzhen (CN)

(72) Inventors: Mahmoud Hasabelnaby, Kelowna (CA); Osama Aboul-Magd, Kanata (CA); Yan Xin, Kanata (CA); Jung Hoon Suh, Kanata (CA); Sara Norouzi, Vancouver (CA)

(21) Appl. No.: 18/819,186

(22) Filed: Aug. 29, 2024

(51) Int. Cl. H04W 52/02

(52) U.S. Cl. CPC H04W 52/0235

(57) ABSTRACT

A communication method has the steps of: obtaining information of an energy state of a first device, and sending to a second device an indication for indicating the information of the energy state.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing energy-state reporting methods for ambient-power wireless local area network (WLAN) devices.

### BACKGROUND

Wireless communication systems such as IEEE 802.11 series (that is, WI-FI® series; WI-FI is a registered trademark of WI-FI Alliance, Austin, TX, USA) are known. Various types of devices such as Internet-of-things (IoT) devices may use WI-FI® systems for communication.

From a deployment cost perspective, the WI-FI® IoT network holds a competitive edge due to its widespread deployment and the utilization of an unlicensed frequency band. However, there are several use cases and applications that current WI-FI® IoT technologies cannot accommodate. For example, devices powered by traditional batteries are not suitable for certain scenarios such as extreme environmental conditions (for example, high pressure, extreme temperatures, extreme humidity, and/or the like). They are also not suitable where maintenance-free devices are required, such as when there is no provision for replacing a device's conventional battery. Furthermore, there are requirements for ultra-low complexity and very small device size or form factor, such as a thickness of millimeters, which existing WI-FI® IoT technologies may not meet.

A promising solution to these unmet requirements is a new generation of IoT devices, known as ambient-power (AMP) devices, which operate on energy harvested from a wide variety of ambient power sources, such as radio waves, solar power, heat, motions, vibrations, and/or the like, thereby eliminating the need for a traditional battery. These devices are characterized by their ultra-low power consumption, with a typical peak power of less than one (1) milliwatt (mW). This low power consumption is due to the low density of ambient power.

One of the key features of the AMP device is its small size and ultra-low complexity, which pave the way for cost-effective, large-scale deployment. This is a significant advantage in the IoT industry, where the number of devices can run into the billions. Another important aspect of the AMP device is its potential for enhancement and compatibility with legacy infrastructure. This means that existing networks can be upgraded to support AMP IoT devices without the need for a complete overhaul.

AMP devices must gather sufficient energy from available sources in the network to perform necessary AMP functions such as data collection, measurement taking, memory retention, data transmission and reception with the network, and/or the like. Once the device accumulates enough energy, it can carry out these operations, which in turn consume the stored energy. When the energy level drops to a point where operations can no longer be sustained, the device begins the process of energy accumulation once again.

However, the access point (AP) may not always know the current energy states of the AMP devices coordinating therewith, and attempts to initiate communication with an AMP station (STA) that has insufficient energy may lead to wasting resources and transmission failures since the AP would spend its own resources and energy trying to send data to an AMP STA that is on the verge of operations' shutting down and would not be able to receive it. Therefore, there is a desire of a reliable way for the network or AP to be aware of the energy levels of AMP STAs, for smooth communication and efficient use of resources.

### SUMMARY

According to one aspect of this disclosure, there is provided a first communication method comprising: obtaining information of an energy state of a first device; and sending to a second device an indication for indicating the information of the energy state.

In some embodiments, the second device is an access point (AP) and the first device is a non-AP station (STA).

In some embodiments, said sending to the second device the indication comprises: sending to the second device the indication when one or more conditions are met, when one or more events occur, or a combination thereof.

In some embodiments, said sending to the second device the indication comprises: sending to the second device the indication when an energy of the first device has passed one of one or more energy-level thresholds.

In some embodiments, said sending to the second device the indication comprises: sending to the second device the indication when one of a plurality of events occurs; and the plurality of events comprise: an energy of the first device having increased and passed a first energy-level threshold, and the energy of the first device having decreased and passed a second energy-level threshold, the second energy-level threshold being smaller than the first energy-level threshold.

In some embodiments, the plurality of events further comprise: the energy of the first device having decreased and passed a third energy-level threshold, the third energy-level threshold being greater than the second energy-level threshold.

In some embodiments, the plurality of events further comprise: receiving from the second device a request for reporting the information of the energy state.

In some embodiments, said sending to the second device the indication comprises: sending to the second device a first frame comprising the indication and non-energy-state-related data.

In some embodiments, said sending to the second device the indication comprises: sending to the second device a first frame comprising the indication.

In some embodiments, the first frame is an action frame.

In some embodiments, the first frame comprises: a first media access control (MAC) header; a first category field indicating that the first frame is related to the information of the energy state; a first action field indicating reporting of the information of the energy state; and the indication.

In some embodiments, the first category field has a value 33, and the first action field has a value one.

In some embodiments, said receiving from the second device the request for reporting the information of the energy state comprises: receiving from the second device a second frame comprising the request for reporting the information of the energy state; and the second frame comprises: a second MAC header, a second category field indicating that the second frame is related to the information of the energy state, and a second action field for indicating the request for reporting the information of the energy state.

In some embodiments, the second category field has a value 33, and the second action field has a value zero.

In some embodiments, the first frame comprises a first MAC header and a first frame check sequence (FCS); the first MAC header comprises a first frame control field, a first destination identifier (ID) field, a first source ID field, and a first type-dependent control field; the first frame control field comprises a first type subfield indicating reporting of the information of the energy state, and a first frame-body-present subfield indicating non-presence of a first frame body; the first destination ID field indicating one or more devices including the second device; the first source ID field indicating the first device; and the first type-dependent control field comprises the indication.

In some embodiments, the first type field has a value one, and the first frame-body-present subfield has a value zero.

In some embodiments, the first frame comprises a first MAC header, a first frame body, and a first FCS; wherein the first MAC header comprises a first frame control field, a first destination identifier (ID) field, a first source ID field, and a first type-dependent control field; the first frame control field comprises a first type subfield indicating reporting of the information of the energy state, and a first frame-body-present subfield indicating presence of the first frame body; the first destination ID field indicating one or more devices including the second device; the first source ID field indicating the first device; the first type-dependent control field comprises the indication; and the frame body comprises non-energy-state-related data.

In some embodiments, the first type field has a value one, and the first frame-body-present subfield has a value zero.

In some embodiments, said receiving from the second device the request for reporting the information of the energy state comprises: receiving from the second device a second frame comprising the request for reporting the information of the energy state; the second frame comprises a second MAC header and a second FCS; the second MAC header comprises a second frame control field, a second destination ID field, and a second source ID field; the second frame control field comprises a second type subfield indicating requesting of the information of the energy state, and a second frame-body-present subfield indicating non-presence of a second frame body; the second destination ID field comprises an ID for indicating one or more devices including the first device; and the second source ID field comprises an ID for indicating the second device.

In some embodiments, the first type field has a value zero, and the first frame-body-present subfield has a value zero.

In some embodiments, said receiving from the second device the request for reporting the information of the energy state comprises: receiving from the second device a second frame comprising the request for reporting the information of the energy state; the second frame comprises a second MAC header, a second frame body, and a second FCS; the second MAC header comprises a second frame control field, a second destination ID field, and a second source ID field; the second frame control field comprises a second type subfield indicating requesting of the information of the energy state, and a second frame-body-present subfield indicating presence of the second frame body; the second destination ID field comprises an ID for indicating multicasting; the second source ID field comprises an ID for indicating the second device; and the frame body comprises IDs of one or more devices including the first device.

In some embodiments, the first type field has a value zero, and the first frame-body-present subfield has a value zero.

In some embodiments, the first frame is a wake-up radio (WUR) frame, and comprises a first MAC header and a first FCS; the first MAC header comprises a first frame control field, a first ID field, and a first type-dependent control field; the first frame control field comprises a first type subfield indicating reporting of the information of the energy state, and a first frame-body-present subfield indicating non-presence of a first frame body; the first ID field indicating the first device; and the first type-dependent control field comprises the indication.

In some embodiments, the first type field has a value five, and the first frame-body-present subfield has a value zero.

In some embodiments, the first frame is a WUR frame, and comprises a first MAC header, a first frame body, and a first FCS; the first MAC header comprises a first frame control field, a first ID field, and a first type-dependent control field; the first frame control field comprises a first type subfield indicating reporting of the information of the energy state, and a first frame-body-present subfield indicating presence of the first frame body; the first ID field indicating one or more devices including the second device; the first type-dependent control field comprises the indication; and the first frame body comprises an ID of the first device.

In some embodiments, the first type field has a value five, and the first frame-body-present subfield has a value one.

In some embodiments, the first frame body also comprises non-energy-state-related data.

In some embodiments, the indication is for indicating a high-energy level of the first device, an alert level of the first device, or a low-energy level of the first device; the indication comprises a percentage of remaining energy of the first device with respect to a first reference energy level; the indication comprises a measurement of the remaining energy of the first device; or the indication comprises a relative energy level with respect to a second reference energy level.

In some embodiments, the indication comprises a status level and a status reference; the status level is for indicating a high-energy level of the first device, an alert level of the first device, or a low-energy level of the first device; and the status reference comprises a metric used for interpreting the status level.

In some embodiments, the indication further comprises a status type having a value for indicating that the indication is for indicating the status level.

According to one aspect of this disclosure, there is provided a second communication method comprising: receiving from a first device an indication for indicating information of an energy state of the first device; and transmitting data to a first device when the indication indicates that the first device has sufficient energy for receiving the data.

In some embodiments, the first device is a non-access-point station (STA).

In some embodiments, the second communication method further comprises: sending a request to the first device for requesting reporting of the energy state of the first device.

In some embodiments, said receiving from the first device the indication for indicating the information of the energy state of the first device comprises: receiving from the first device a first frame comprising the indication.

In some embodiments, said receiving from the first device the indication for indicating the information of the energy state of the first device comprises: receiving from the first device a first frame comprising the indication and non-energy-state-related data.

According to one aspect of this disclosure, there is provided an apparatus comprising: one or more non-transitory computer-readable storage devices comprising computer-executable instructions; and one or more processors functionally coupled to the one or more non-transitory computer-readable storage devices; the instructions, when executed, cause the one or more processors to perform the above-described methods.

According to one aspect of this disclosure, there is provided one or more non-transitory computer-readable storage devices comprising computer-executable instructions, wherein the instructions, when executed, cause one or more processors to perform the above-described methods.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided one or more non-transitory computer-readable storage devices comprising computer-executable instructions, wherein the instructions, when executed, cause one or more circuits to perform the above-described methods.

According to one aspect of this disclosure, there is provided an apparatus, and configured to perform the any one of above mentioned methods and their embodiments. Specifically, the apparatus includes one or more units configured to perform the any one of above mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of above mentioned methods and their embodiments.

According to one aspect of this disclosure, there is provided a computer program product including one or more instructions. When the instructions are executed by an apparatus such as a computer, the apparatus is enabled to implement the any one of above mentioned methods and their embodiments.

According to one aspect of this disclosure, there is provided a computer program. When the computer program is executed by a computer, an apparatus is enabled to implement the any one of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

By utilizing the methods disclosed herein, the AP may effectively schedule data transmissions to STAs, avoiding communication initiation with STAs that lack sufficient power, which leads to significant improvements in network efficiency and a reduction in wasted resources.

The methods disclosed herein address several critical limitations of current communication protocols, and offer significant benefits for both the network and the STAs.

With the methods disclosed herein, the AP receives updates on the STA's energy state, which enables the AP to make informed decisions about data transmissions based on the reported energy state of the STA, thereby leading to:
reducing wasted resources: The AP avoids transmitting data to STAs with insufficient energy, thereby preventing wasted network resources and potential data loss.
optimizing critical data scheduling: The AP may schedule critical data transmissions strategically, for example, only when the STA has enough energy to process them.
reducing retransmissions: Knowing the STA's energy state helps the AP to avoid failed transmissions, thereby reducing the need for retransmissions and improving overall network performance.

In some embodiments, the method disclosed herein uses an event-based method to trigger STA's energy-state reporting such that the ELSR is only transmitted under one or more conditions (such as at high-energy level, critically low-energy threshold, or upon AP's request), which minimizes energy that may otherwise waste on frequent reporting, and thereby gives rise to reduced energy consumption.

In some embodiments, the methods disclosed herein enables the STA to transmit the energy-state information with data packets, which eliminates the need for separate transmissions for energy-state reporting, thereby leading to reduced overhead and energy consumption.

Thus, the methods disclosed herein give rise to a more efficient communication ecosystem for devices. The network operates with improved resource allocation and scheduling, while STAs conserve their limited energy resources by avoiding unnecessary reporting. This translates to a more robust and sustainable network environment for STAs.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing three zones of power balance for ambient-power (AMP) STAs;

FIG. 5 is a schematic diagram showing an example of AMP STA operation energy states;

FIG. 6 is a schematic diagram showing an example of an AMP STA sending energy-level status reports (ELSRs) to an AP using an energy-state reporting method, according to some embodiments of this disclosure;

FIG. 7 is a schematic diagram showing the structure of an action frame, according to some embodiments of this disclosure;

FIG. 8 shows a portion of Table 9-81 of IEEE P802.11-REVme™/D5.0, February 2024, entitled “Draft Standard for Information Technology-Telecommunications and Information Exchange between Systems Local and Metropolitan Area Networks-Specific Requirements, Part 11: Wireless LAN Medium Access Control (MAC) and Physical Layer (PHY) Specifications” (denoted “IEEE P802.11-REVme/D5.0”) defining the values of the category field of a management frame;

FIG. 9 shows a portion of Table 9-81 shown in FIG. 8 with modifications according to some embodiments of this disclosure;

FIG. 10 is a schematic diagram showing the structure of an AMP STA alive check frame, according to some embodiments of this disclosure;

FIG. 11 is a schematic diagram showing the structure of an AMP STA status indication frame, according to some embodiments of this disclosure;

FIG. 12 is a schematic diagram showing the structure of the AMP status indication field of the AMP STA status indication frame shown in FIG. 11, according to some embodiments of this disclosure;

FIG. 13 is a schematic diagram showing the structure of an AMP short frame, according to some embodiments of this disclosure;

FIG. 14 is a schematic diagram showing the structure of the MAC header of the AMP short frame shown in FIG. 13, according to some embodiments of this disclosure;

FIG. 15 is a schematic diagram showing the structure of the frame control field of the MAC header shown in FIG. 14, according to some embodiments of this disclosure;

FIG. 16A is a schematic diagram showing the structure of an AMP STA status request frame sent from an AP to an AMP STA to request its current energy level to check whether the AMP STA has enough energy for uplink (UL) and/or downlink (DL) transmission, according to some embodiments of this disclosure;

FIG. 16B is a schematic diagram showing the structure of an AMP STA status request frame sent from an AP to a plurality of AMP STAs for requesting ELSR therefrom using multicast, according to some embodiments of this disclosure;

FIG. 17 is a schematic diagram showing an example of the structure of the AMP STA information field in the frame body field of the AMP STA status request frame shown in FIG. 16B, according to some embodiments of this disclosure;

FIG. 18 is a schematic diagram showing the structure of an AMP STA status frame sent from an AMP STA to an AP to report its current energy level, according to some embodiments of this disclosure;

FIG. 19 is a schematic diagram showing the structure of the type-dependent control field of the AMP STA status frame shown in FIG. 18, according to some embodiments of this disclosure;

FIG. 20 is a schematic diagram showing the structure of the type-dependent control field of the AMP STA status frame shown in FIG. 18, according to some other embodiments of this disclosure;

FIG. 21 is a schematic diagram showing the structure of the type-dependent control field of the AMP STA status frame shown in FIG. 18, according to yet some other embodiments of this disclosure;

FIG. 22 is a schematic diagram showing the structure of a modified wake-up radio (WUR) frame modified from the conventional WUR frame defined in IEEE 802.11ba, according to some embodiments of this disclosure;

FIG. 23 is a schematic diagram showing the structure of the MAC header of the modified WUR frame shown in FIG. 22, according to some embodiments of this disclosure;

FIG. 24 is a schematic diagram showing the structure of the frame control field of the MAC header shown in FIG. 23, according to some embodiments of this disclosure;

FIG. 25 is a table reproduced from Table 9-674 in subsection 9.9 of IEEE P802.11-REVme/D5.0, listing the values and meaning of the type subfield of a WUR frame;

FIG. 26 is a schematic diagram showing the structure of the modified WUR frame shown in FIG. 22 used as an AMP STA status frame, according to some embodiments of this disclosure;

FIG. 27 is a schematic diagram showing the structure of the type-dependent control field of the AMP STA status frame shown in FIG. 26, according to some embodiments of this disclosure;

FIG. 28 is a schematic diagram showing an example of the structure of the modified WUR frame shown in FIG. 22 used as an AMP STA status frame, according to some embodiments of this disclosure;

FIG. 29A is a schematic diagram showing the structure of the type-dependent control field of the AMP STA status frame shown in FIG. 28, according to some embodiments of this disclosure;

FIG. 29B is a schematic diagram showing the structure of the type-dependent control field of the AMP STA status frame shown in FIG. 28, according to some other embodiments of this disclosure;

FIG. 30 is a schematic diagram showing the structure of an example of the structure of the modified WUR frame shown in FIG. 22 used as an AMP STA status frame, according to some embodiments of this disclosure;

FIG. 31 is a schematic diagram showing an example of the structure of the AMP STA information field in the frame body field of the AMP STA status frame shown in FIG. 22, according to some embodiments of this disclosure;

FIGS. 32 and 33 show the structures of the AMP STA status frame, respectively, according to various embodiments of this disclosure;

FIG. 34 is a schematic diagram showing an example of the structure of the AMP STA data frame, according to some embodiments of this disclosure;

FIG. 35 is a schematic diagram showing an example of the structure of the AMP STA data frame, according to some other embodiments of this disclosure;

FIG. 36 is a schematic diagram showing an example of the structure of the AMP STA data frame, according to yet some other embodiments of this disclosure;

FIG. 37 is a schematic diagram showing an example of the structure of the AMP STA data frame, according to still some other embodiments of this disclosure; and

FIG. 38 is a schematic diagram showing an example of the structure of the AMP STA data frame, according to yet still some other embodiments of this disclosure.

### DETAILED DESCRIPTION

Embodiments disclosed herein relate to systems, apparatuses, methods, and non-transitory computer-readable storage devices for wireless communication employing energy-state reporting methods for devices such as ambient-power (AMP) wireless local area network (WLAN) devices. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

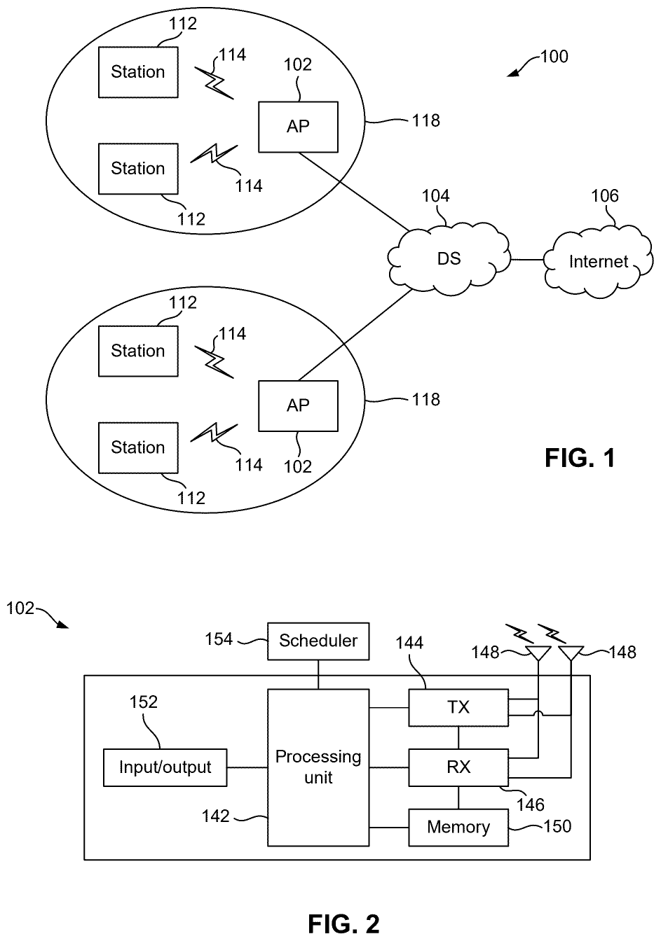

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

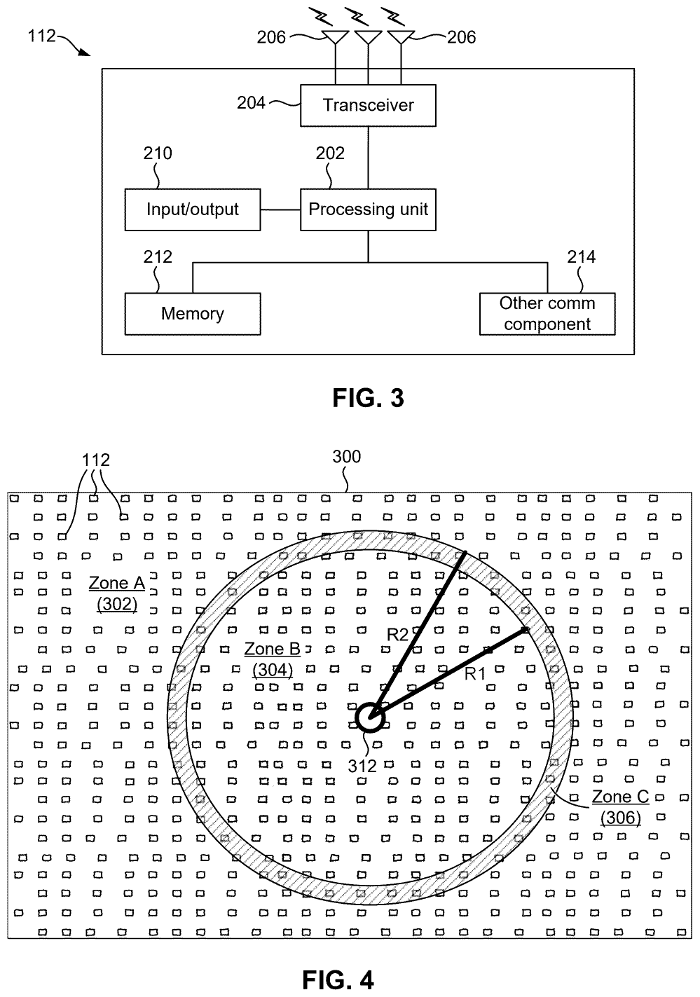

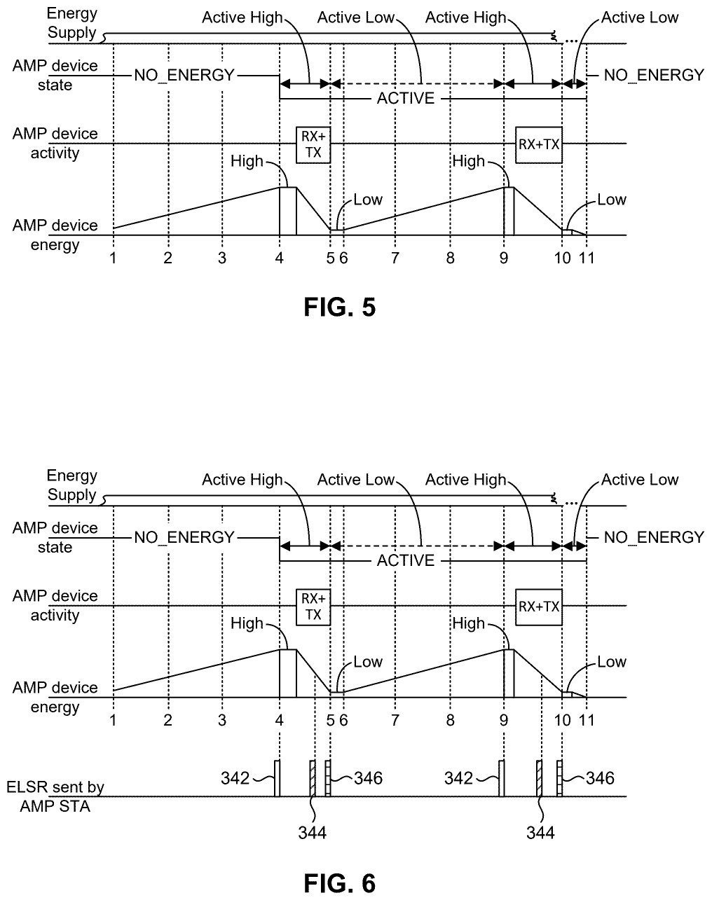

FIG. 3 is a simplified schematic diagram of a STA 112. As shown, the STA 112 comprises at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Energy-State Reporting Methods

As described above, some STAs 112 such as AMP STAs, from time to time, may have insufficient energy for full capacity wireless communication, or may not have the energy for wireless communication at all.

Accordingly, as shown in FIG. 4 (reproduced from IEEE 802.11-24/0826r1, “Energy balance of the state-based AMP station” (denoted “IEEE 802.11-24/0826r1”) by Solomon Trainin, et al., with modifications), a site 300 having one or more AMP STAs 112 may be partitioned into a plurality of zones, such as three zones: zone A (302), zone B (204), and zone C (306), based on the distance from an energy source 312 therein, wherein an AMP STA 112 in zone A (302) does not accumulate enough energy to respond to trigger frames sent by an AP 104 (not shown); an AMP STA 112 in zone B (304) can respond to trigger frames and is capable of memory retention and additional functionality; and an AMP STA 112 in zone C (306) can respond to trigger frames but cannot retain memory or provide additional functionality.

AMP STAs located in zones A and C can transition into zone B after, for example, a high periodicity of the energizing waveform and/or an increased power output from the energizer 312.

In some embodiments, the operation energy states of an AMP STA 112 may be defined as follows based on its energy level. Note that the states defined below do not necessarily correspond to the zones shown in FIG. 4.
No-energy state, which is the state when the AMP STA 112 does not have enough energy to response to trigger frames sent by an AP 104; and
Active state, which is the state when the AMP STA 112 has enough energy to respond to trigger frames sent by an AP 104.

The Active state may be partitioned into two substates:
Active-low state, which is the state when the AMP STA 112 has enough energy to respond to trigger frames but cannot retain memory or provide additional functionality; and
Active-high state, which is the state when the AMP STA 112 has enough energy to respond to trigger frames and is capable of memory retention and additional functionality.

As shown in FIG. 6, the energy source generates supply of energy, and the AMP STA 112 uses it to accumulate energy. The AMP STA 112 cannot perform receiving (RX) and transmitting (TX) until its energy becomes high (for example, transitioning from the no-energy state to the active-high state).

Once the AMP STA 112 is in the active-high state and has high energy, it is ready for RX and TX. As RX and TX consume energy, the AMP STA 112 is at low energy level (for example, transitioning from the active-high state to the active-low state) when RX and TX are completed. Even at low energy (for example, in the active-low state), the AMP STA 112 can perform some functions, for example, taking measurements, storing information, and receiving.

The AMP STA 112 may accumulate energy for the next RX and TX.

On the other hand, if the AMP STA 112 does not receive enough or no energy supply, the AMP STA 112 may go into the no-energy state after exhausting its energy.

The AMP STA's state is contingent on the amount of energy it has accumulated. When it has no energy, it has to accumulate energy before it can perform any other activities. However, when it is in the active-high state, the AMP STA 112 can perform any activity. In the active-low state, the AMP STA 112 can perform functions that require less energy, such as memory retention, sensing, and/or the like.

The AMP STA 112 may require some time to prepare its energy supply for the RX+TX phase, which corresponds to the active-high state. After the RX+TX phase, the AMP STA's ability to support the active-low state is uncertain. This uncertainty is dependent on the implementation. Some AMP STAs may not support the active-low state at all, while others may support the active-low state depending on the circumstances. For instance, the RX+TX phase may deplete all the accumulated energy, and consequently, the AMP STA 112 would have no energy to stay in the active-low state.

Current communication protocols between AP 102 and AMP STAs 112 lack a reliable mechanism for AMP STAs 112 to report their energy state, which may lead to several technical challenges:
Uninformed network management: The AP 102 cannot make informed decisions about data transmission due to lack of knowledge regarding the AMP STA's current energy level, which may lead to:
   Wasted network resources: The AP 102 may transmit data packets to an STA 112 with insufficient energy to receive the data packets, resulting in wasted network resources as the data cannot be received.
   Potential data loss: If the AP 102 is unaware of the STA's low energy state, data transmissions may fail, thereby leading to potential data loss.

Inefficient scheduling: Without knowledge of the STA's availability for high-energy operations, the AP 102 cannot schedule data transmissions effectively, which may lead to wasted energy on both the AP and AMP STA sides.

These limitations highlight the critical need for a robust mechanism for AMP STAs 112 to report their energy state to the network, which may enable the AP 102 to make informed decisions about data transmission, thereby ultimately improving network efficiency and reducing wasted resources.

In the following, various energy-state reporting methods are disclosed, which may be used by AMP STAs 112 to communicate their current energy state to the AP 102 or network, via, for example, the energy-level status reports (ELSRs).

In various embodiments, the ELSR may be triggered in any suitable ways. For example, in some embodiments, event-based triggering may be used, wherein transmission of the ELSR is triggered by certain events, such as sent when the AMP STA 112 reaches certain energy levels or when triggered by the AP 102.

In some embodiments, piggybacking may be used, wherein the energy-state information or ELSR is embedded in data packets transmitted by the AMP STA 112, thereby minimizing additional overhead.

In various embodiments, the ELSR may be requested by the AP 102 and reported by the AMP STA 112 using any suitable format or any suitable frame format.

For example, in some embodiments, AMP action frames may be used, which provide targeted functionality for specific AMP tasks such as verifying AMP STA aliveness and reporting its energy levels.

In some embodiments, AMP short frames may be used, wherein the AMP short frames are similar to the wake-up radio (WUR) frames defined in IEEE 802.11ba standard, and provide a lightweight solution for frequent, low-overhead communication.

In some embodiments, the WUR frame may be used as the AMP short frame for AMP STA energy-state reporting, with new WUR frame types defined for indicating that the WUR frame is used as the AMP short frame, thereby allowing simple and low-overhead energy-state reporting with backward compatibility (that is, compatible with existing IEEE 802.11 standards).

Accordingly, by using the energy-state reporting methods described herein, the AP 102 may effectively schedule data transmissions to AMP STAs 112, thereby avoiding initiating communication with AMP STAs 112 that lack sufficient power, and leading to significant improvements in network efficiency and reduced wasted resources.

The energy-state reporting methods described herein may be used by any STAs 112 (and APs 102) such as battery-less, maintenance-free, AMP IoT devices and/or non-AMP devices (such as those powered by batteries or electricity grids). Moreover, the energy-state reporting methods described herein may be suitable for the standardization of next generation of IEEE 802.11 bp for ambient power-enabled (AMP) IoT devices, and other future wireless communication standards.

In some embodiments, the ELSR reporting is triggered when one or more conditions are met. For example, in some embodiments, the ELSR reporting is triggered when one or more events occur, such as when the energy of the AMP STA 112 (such as the energy stored in the AMP STA 112 or the energy of the AMP STA 112 that is available for use in wireless communication) changes and passes one of one or more energy levels (for example, increasing from smaller than an energy level to greater than the energy level, or decreasing from greater than an energy level to smaller than the energy level). When such an event occurs, the AMP STA 112 sends to the AP 102 an ELSR comprising information related to the AMP STA's energy level such as an indication indicating its current energy level or indicating the AMP STA's capability for wireless communication under its current energy level.

FIG. 6 is a schematic diagram showing an example of an AMP STA 112 sending ELSRs to an AP 102 using the energy-state reporting method, according to some embodiments of this disclosure. In these embodiments, three energy level thresholds are used for triggering ELSR reporting, including, from high to low, a high-energy level threshold 342, an alert level threshold 344, and a low-energy level threshold 346:
High-energy level 342: When the energy level of the AMP STA 112 increases and passes the high-energy level 342, the AMP STA 112 sends to the AP 102 an ELSR indicating that the AMP STA 112 has accumulated sufficient energy for data reception and transmission and is capable to maintain all other operational functionalities. When the AP 102 receives from the AMP STA 112 this ELSR, the AP 102 knows that the AMP STA 112 is primed to receive data and manage control transmissions.
Alert level 344: When the energy level of the AMP STA 112 decreases and passes the alert level 344, the AMP STA 112 sends to the AP 102 an ELSR indicating that the energy of the AMP STA 112 has significantly decreased and will be depleted soon. When the AP 102 receives from the AMP STA 112 an ELSR indicating the alert level 344, the AP 102 may prioritize its communication with the AMP STA 112 to transmit and/or receive critical data before the AMP STA 112 loses power entirely.
Low-energy level 346: indicating that the energy of the AMP STA 112 is at very low level that the AMP STA can only perform basic operational functionalities and transmit a final ELSR report. When the AP 102 receives from the AMP STA 112 an ELSR indicating the low-energy level 346, the AP 102 knows that the AMP STA 112 has paused data transmission and reception. Accordingly, the AP 102 will postpone sending any data packets to the AMP STA 112 until its energy level recovers.

Using these energy level thresholds ensures that the AP 102 or network is alerted when the AMP STA 112 is primed to receive data and manage control transmissions, and also before the AMP STA 112 completely depletes its power. Moreover, ELSR Reports are dispatched only when they are required, thereby minimizing the total energy consumption of the AMP STA 112.

Those skilled in the art will appreciate that, in other embodiments, other energy-level thresholds and/or other number of energy-level thresholds may be used. For example, in some embodiments, the alert level 344 is not used. In other words, only the high-energy level 342 and low-energy level 346 are used.

In some embodiments, the ELSR reporting may be triggered by the AP 102. In these embodiments, before initiating critical management operation (for example, network reconfiguration) or critical data transmission for the AMP STA 112, the AP 102 may send an ELSR request to the AMP STA 112 requesting an ELSR, which allows the AP 102 to determine whether it will postpone updates or prioritize data transmission.

More specifically, if the ELSR indicates that the energy level of the AMP STA 112 is insufficient, the AP 102 may delay the updates (that is, postponing updates) to avoid potential disruption and wasting of resources. The update may be rescheduled to a time when the AMP STA 112 has accumulated sufficient energy.

On the other hand, if the AMP STA 112 has enough energy, the AP 102 may prioritize scheduling the critical data transmission (that is, prioritizing data transmission), thereby ensuring timely retrieval of important information.

In some embodiments, the management action frames may be used for signaling of ELSR requesting and/or reporting between the AMP STA 112 and the AP 102.

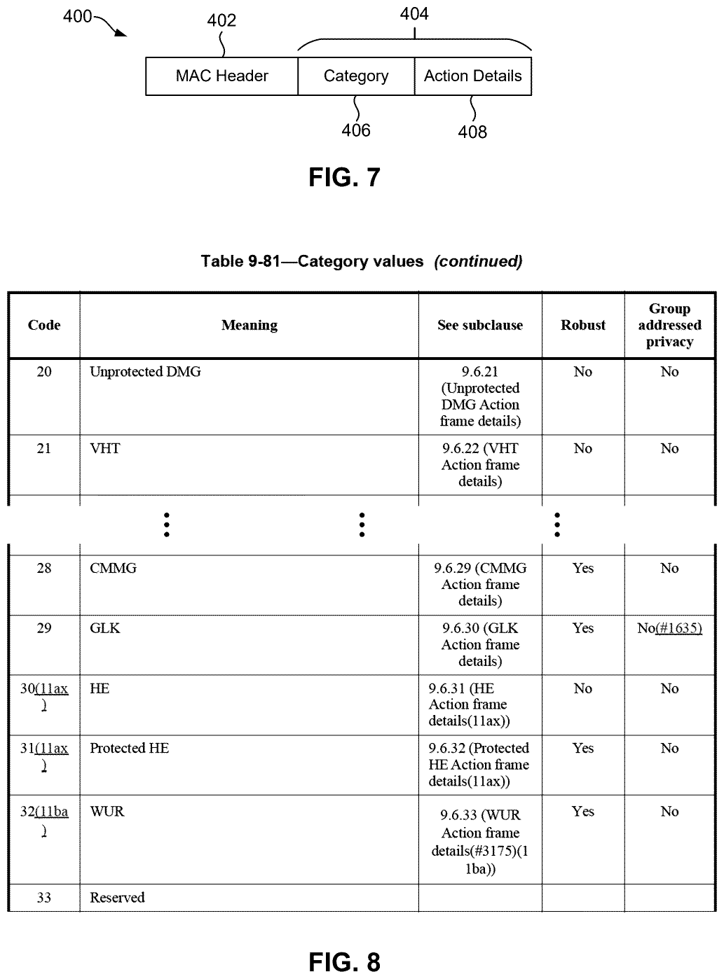

As those skilled in the art understand, action Frames are a type of management frames for triggering an action in a cell. As shown in FIG. 7, an action frame 400 comprises a media access control (MAC) header 402 and an action field 404. The action field 404 comprises a category field 406 and an action details field 408.

IEEE P802.11-REVme™/D5.0, February 2024, entitled “Draft Standard for Information Technology-Telecommunications and Information Exchange between Systems Local and Metropolitan Area Networks-Specific Requirements, Part 11: Wireless LAN Medium Access Control (MAC) and Physical Layer (PHY) Specifications” (denoted “IEEE P802.11-REVme/D5.0”) defines the values of the category field 406 in its Table 9-81. FIG. 8 shows a portion of this table. As shown, in this standard, value 33 of the category field 406 is reserved (that is, unused).

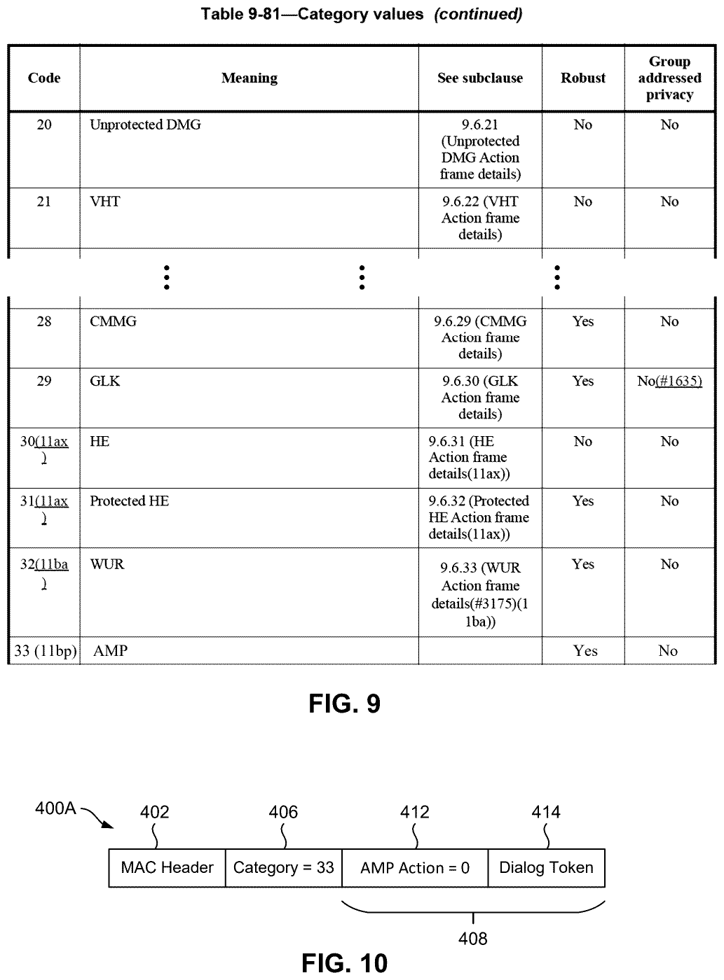

As shown in FIG. 9 (as an example for future IEEE 802.11 bp), in these embodiments, value 33 of the category field 406 is used as “AMP” for indicating ELSR requesting and/or reporting between the AMP STA 112 and the AP 102, with the “robust” property being “yes” and “group addressed privacy” property being “no”. Accordingly, an action frame 400 with the category field 406 being a value of 33 is denoted an AMP action frame.

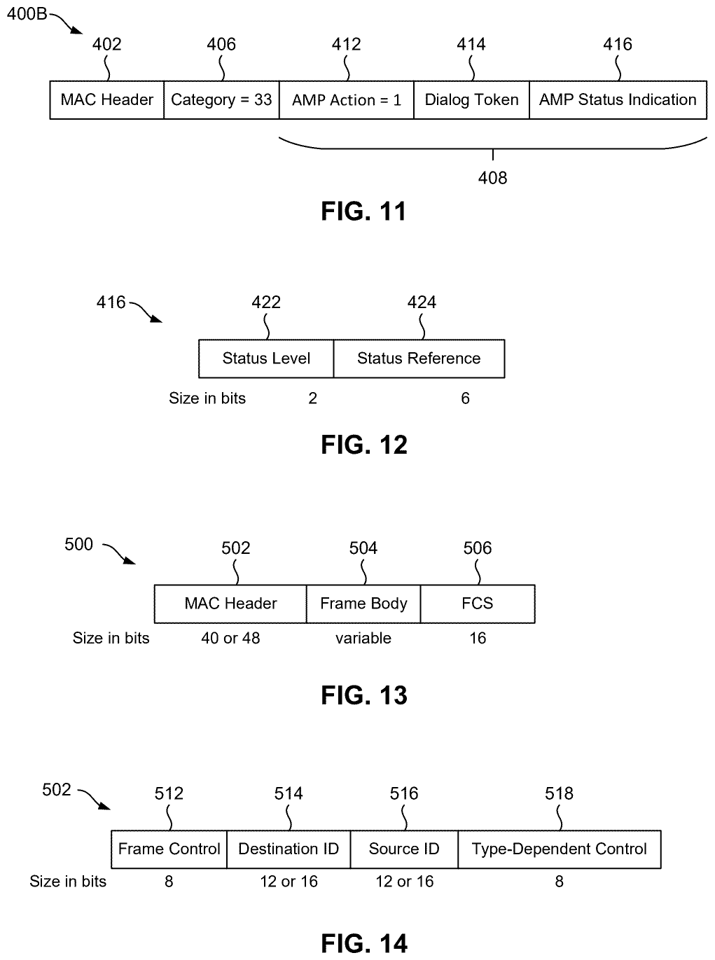

When the category field 406 has a value of 33, the action details field 408 of the AMP action frame 400 comprises (for example, starts with) an AMP action field 412 (see FIGS. 10 and 11), which has, for example, a length of one byte or one octet. As shown in Table I below, the AMP action field 412 has a first value such as zero (0) for indicating AMP STA alive check, or a second value such as one (1) for indicating AMP STA status indication. Vaues 2 to 255 of the AMP action field 412 are not used (that is, reserved).

TABLE I
VALUES AND MEANINGS OF THE AMP ACTION
FIELD OF THE AMP ACTION FRAME

| Value | Meaning |
|---|---|
| 0 | AMP STA Alive Check |
| 1 | AMP STA Status Indication |
| 2-255 | Reserved |

More specifically, the AMP action field 412 of the AMP action frame 400 set to zero (0) indicates that the AMP action frame 400 is an AMP STA alive check frame sent from the AP 102 to the AMP STA 112 as an AP-triggered ELSR request (that is, for requesting the AMP STA 112 to send ELSR) to check whether the AMP STA 112 is still alive and has enough energy for uplink (UL) and/or downlink (DL) transmission. FIG. 10 is a schematic diagram showing the structure of the AMP STA alive check frame 400A, which comprises a MAC header 402, a category field 406 having a value of 33, an AMP action field 412 having a value of zero (0), and a dialog token field 414. As those skilled in the art understand, the dialog token field 414 is used for matching action responses with action requests when there are multiple, concurrent action requests.

The AMP action field 412 of the AMP action frame 400 set to one (1) indicates that the AMP action frame 400 is an AMP STA status indication frame sent from the AMP STA 112 to the AP 102 (for example, as a response to the AMP STA alive check frame, or when the AMP STA's energy level passes an energy-level threshold) for reporting its ELSR. FIG. 11 is a schematic diagram showing the structure of the AMP STA status indication frame 400B, which comprises a MAC header 402, a category field 406 having a value of 33, an AMP action field 412 having a value of one (1), a dialog token field 414, and an AMP status indication field 416.

In some embodiments, the AMP status indication field 416 has a length of eight (8) bits in size. As shown in Table II below, the AMP status indication field 416 has a first value such as zero (0) for indicating the high-energy level 342, a second value such as one (1) for indicating the alert level 344, or a third value such as two (2) for indicating the low-energy level 346. Values 3 to 255 are not used (that is, reserved for other non-energy related status reports (which may be defined in the future)).

TABLE II
VALUES AND MEANINGS OF THE AMP STATUS INDICATION
FIELD OF THE AMP STA STATUS INDICATION FRAME

| Value | Meaning |
|---|---|
| 0 | High-Energy Level |
| 1 | Alert Level |
| 2 | Low-Energy Level |
| 3-255 | Reserved |

In some embodiments, the AMP status indication field 416 has a length of eight (8) bits in size and indicates a percentage of the remaining energy of the AMP STA 112 (with respect to a reference energy level such as the full energy level thereof).

In some embodiments, the AMP status indication field 416 has a length of eight (8) bits in size and indicates a measurement of the remaining energy (such as the amount expressed in microjoules) of the AMP STA 112.

In some embodiments, the AMP status indication field 416 has a length of eight (8) bits in size and indicates a relative energy level with respect to a reference energy level, for example, the difference between the remaining energy of the AMP STA 112 and the reference energy level such as the high-energy level threshold 342 thereof.

FIG. 12 is a schematic diagram showing the structure of the AMP status indication field 416, according to some embodiments of this disclosure. As shown, the AMP status indication field 416 in these embodiments comprises a status level field 422 (for example, having a length of two (2) bits) and a status reference field 424 (for example, having a length of six (6) bits).

As shown in Table III below, the status level field 422 has a first value such as zero (0) for indicating the high-energy level 342, a second value such as one (1) for indicating the alert level 344, or a third value such as two (2) for indicating the low-energy level 346. The value 3 of the status level field 422 is not used (that is, reserved).

TABLE III
VALUES AND MEANINGS OF THE STATUS LEVEL FIELD
OF THE AMP STA STATUS INDICATION FRAME

| Value | Meaning |
|---|---|
| 0 | High-Energy Level |
| 1 | Alert Level |
| 2 | Low-Energy Level |
| 3 | Reserved |

The status reference field 424 comprises the value of the metric used to enable the AP 102 or the energizer source who receives the AMP STA status indication frame 400B to interpret the status level 422. For example, in some embodiments, the status reference field 424 may comprise the maximum capacity of the energy storage in millijoules (mJ) with a granularity of 0.4 mJ. In some embodiments, the status reference field 424 may comprise the percentage of the remaining energy (with respect to the maximum capacity of the energy storage) with a tolerance of +1.587% or −1.587%.

In some embodiments, short frames (denoted “AMP short frames”) may be used for signaling of ELSR requesting and/or reporting between the AMP STA 112 and the AP 102.

FIG. 13 is a schematic diagram showing the structure of the AMP short frame 500, which comprises a MAC header 502 of a length of up to 48 bits (such as 40 bits or 48 bits), a frame body 504 of a variable length, and a 16-bit frame check sequence (FCS) 506. As shown in FIG. 14, the MAC header 502 comprises an eight-bit frame control field 512, a 12-bit or 16-bit destination identifier (ID) field 514, a 12-bit or 16-bit source ID field 516, and an eight-bit type-dependent control field 518.

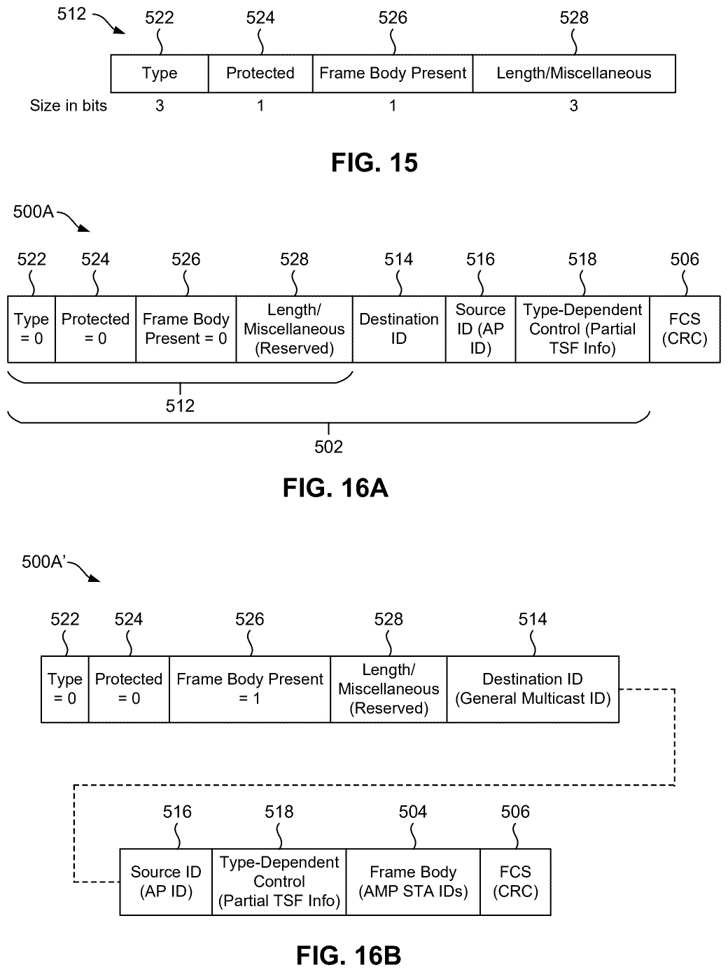

As shown in FIG. 15, the frame control field 512 may be the similar to the frame control field defined in IEEE P802.11-REVme/D5.0, and comprises a three-bit type subfield 522, a one-bit protected subfield 524, a one-bit frame body present subfield 526, and a length/miscellaneous subfield 528.

As shown in Table IV below, the type subfield 522 has a first value such as zero (0) for indicating that the AMP short frame 500 is a AMP STA status request frame, a second value such as one (1) for indicating that the AMP short frame 500 is an AMP STA status frame, and a third value such as two (2) for indicating that the AMP short frame 500 is a AMP STA data frame. Values 3 to 7 are not used (that is, reserved).

TABLE IV
VALUES AND MEANINGS OF THE TYPE
SUBFIELD OF THE AMP SHORT FRAME

| Value | Meaning |
|---|---|
| 0 | AMP STA Status Request |
| 1 | AMP STA Status |
| 2 | AMP STA Data Frame |
| 3-7 | Reserved |

The protected subfield 524 is set to one (1) if the AMP short frame 500 is protected utilizing, for example the message integrity check (MIC) algorithm; otherwise, it is set to zero (0) to indicate that the AMP short frame 500 contains the 16-bit cyclic redundancy check (CRC).

Reception of protected AMP short frames 500 (wherein the protected subfield 524 is set to one (1)) may drain more energy compared to reception of unprotected AMP frames (wherein the protected subfield 524 is set to zero (0)). Therefore, from AMP STA's perspective, it may be preferable that protection of AMP frames is enabled only when required.

The frame body present subfield 526 indicates whether or not a frame body field 504 is included in the AMP short frame 500, for example, having a value of one (1) for indicating the presence of a frame body field 504 in the AMP short frame 500, and having a value of zero (0) for indicating that no frame body field 504 is included in the AMP short frame 500.

If the frame body field 504 is present, the length/miscellaneous subfield 528 of the frame control field 512 comprises an indication of the length of the frame body field 504, such as a value L, wherein the length of the frame body field 504 is in units of octets and is calculated as 2×(L+1), that is,

$$Length of the frame body field = 2 \times ( L + 1 ) . \qquad ( 1 )$$

FIG. 16A is a schematic diagram showing the structure of the AMP STA status request frame 500A sent from the AP 102 to the AMP STA 112 to request its current energy level to check whether the AMP STA 112 has enough energy for UL and/or DL transmission. As shown in FIG. 16A:
the type subfield 522 of the frame control field 512 in the MAC header 502 is set to zero (0);
the protected subfield 524 of the frame control field 512 in the MAC header 502 is set to zero (0);
the frame body present subfield 526 of the frame control field 512 in the MAC header 502 is set to 0;
the length/miscellaneous subfield 528 of the frame control field 512 in the MAC header 502 is reserved;
the destination ID field 514 in the MAC header 502 may comprise an AMP STA's ID, a group ID, or a broadcast ID (described in more detail below);
the source ID field 516 in the MAC header 502 comprises the ID of the AP 102;
the type-dependent control field 518 in the MAC header 502 comprises partial timing synchronization function (TSF) information (wherein TSF is a counter maintained by the AP 102 for tracking time, which helps devices such as AMP STAs 112 to synchronize their clocks with the AP's clock for coordinated operation);
no frame body field 504 is included in the AMP STA status request frame 500A; and the FCS field 506 comprises the CRC.

As described above, the destination ID field 514 in the MAC header 502 may comprise an AMP STA's ID, a group ID, or a broadcast ID, thereby allowing the AP 102 to request ELSR from one or more AMP STAs.

More specifically, the AP 102 may send an AMP STA status request frame 500A with the destination ID field 514 in the MAC header 502 thereof comprising the ID of one AMP STA 112 (that is, unicast) for requesting ELSR from that AMP STA 112.

The AP 102 may send an AMP STA status request frame 500A with the destination ID field 514 in the MAC header 502 thereof comprising a broadcast ID (that is, broadcast) for requesting ELSR from all AMP STAs 112.

The AP 102 may send an AMP STA status request frame 500A with the destination ID field 514 in the MAC header 502 thereof comprising a group ID representing a plurality of AMP STAs 112 (that is, multicast) for requesting ELSR from those AMP STAs 112.

In some embodiments as shown in FIG. 16B, the AP 102 may send an AMP STA status request frame 500A′ for requesting ELSR from a plurality of AMP STAs 112 using multicast. The AMP STA status request frame 500A′ is similar to the AMP STA status request frame 500A shown in FIG. 16A except that the AMP STA status request frame 500A′ comprises a frame body field 504 which comprises the IDs of the plurality of AMP STAs 112, and that the frame body present subfield 526 of the frame control field 512 in the MAC header 502 is set to one (1) for indicating the presence of the frame body field 504, and the destination ID field 514 in the MAC header 502 comprises a general multicast ID for indicating that multicast is to be used.

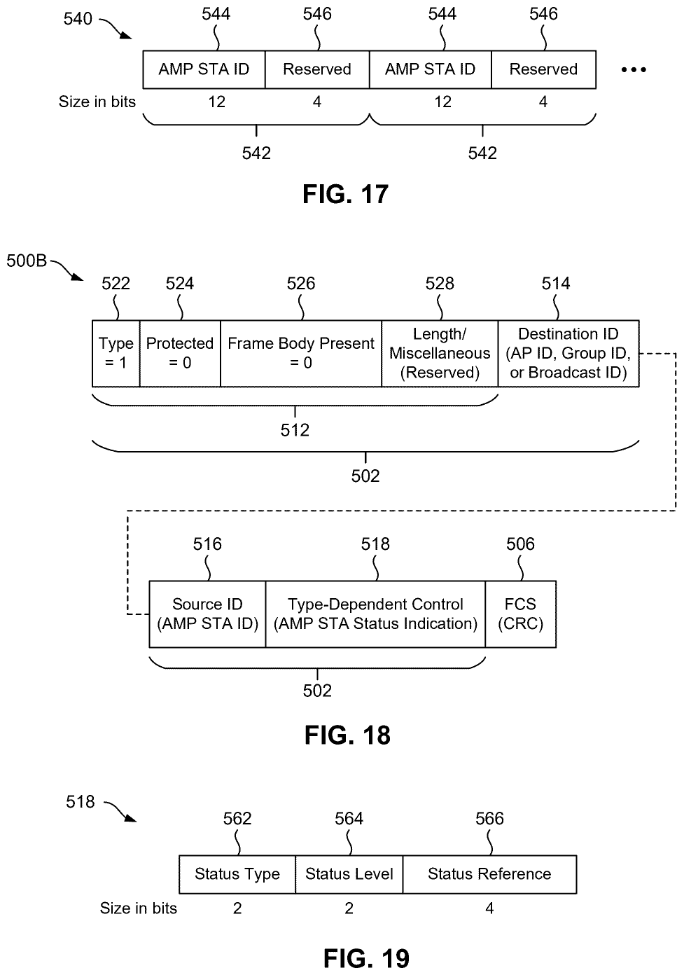

In some embodiments, the IDs of the plurality of AMP STAs 112 may be included in an AMP STA information field in the frame body field 504. FIG. 17 shows an example of the structure of the AMP STA information field 540, which comprises one or more two-byte ID fields 542, and each ID field 542 comprises a 12-bit AMP STA ID 544 and a four-bit reserved (unused) subfield 546 for alignment.

In these embodiments, as the frame body field 504 is present, the length/miscellaneous subfield 528 of the frame control field 512 comprises an indication of the length of the frame body field 504, such as a value L, wherein the length of the frame body field 504 is calculated using Equation (1).

FIG. 18 is a schematic diagram showing the structure of the AMP STA status frame 500B sent from the AMP STA 112 to the AP 102 to report its current energy level (as a response to the AMP STA status request frame 500A received from the AP 102 or when the AMP STA's energy level passes an energy-level threshold). As shown in FIG. 18:
the type subfield 522 of the frame control field 512 in the MAC header 502 is set to one (1);
the protected subfield 524 of the frame control field 512 in the MAC header 502 is set to zero (0);
the frame body present subfield 526 of the frame control field 512 in the MAC header 502 is set to 0;
the length/miscellaneous subfield 528 of the frame control field 512 in the MAC header 502 is reserved;
the destination ID field 514 in the MAC header 502 comprises the ID of the AP 102;
the source ID field 516 in the MAC header 502 comprises the ID of the AMP STA 112;
the type-dependent control field 518 in the MAC header 502 comprises an indication of the AMP STA current energy state;
no frame body field 504 is included in the AMP STA status request frame 500A; and
the FCS field 506 comprises the CRC.

In various embodiments, the type-dependent control field 518 in the MAC header 502 may comprise any suitable indication for indicating the AMP STA current energy state.

For example, in some embodiments, the type-dependent control field 518 may be an eight-bit field and have a first value such as zero (0) for indicating the high-energy level 342, a second value such as one (1) for indicating the alert level 344, or a third value such as two (2) for indicating the low-energy level 346. Values 3 to 255 are reserved (which may be defined in the future for other uses such as non-energy related status reports).

In some embodiments, the type-dependent control field 518 may comprise a percentage of the remaining energy of the AMP STA 112.

In some embodiments, the type-dependent control field 518 may comprise a measurement of the remaining energy of the AMP STA 112, for example, expressed in microjoules with a granularity of 100 microjoules.

In some embodiments, the type-dependent control field 518 may comprise an indication of a relative energy level being, for example, the difference between the remaining energy of the AMP STA 112 and the low-energy level 346 thereof.

In some embodiments as shown in FIG. 19, the type-dependent control field 518 may comprise a two-bit status type subfield 562, a two-bit status level subfield 564, and a four-bit status reference subfield 566.

The status type subfield 562 may have a first value such as zero (0) for indicating that the rest of the type-dependent control field 518 indicates the energy or status level of the AMP STA 112 (see below). Values one (1) to three (3) are reserved (which may be used in the future for other purposes such as non-energy related status reports), and when status type subfield 562 has a value of one (1), two (2), or (3), the status level subfield 564 and the status reference subfield 566 are also reserved (that is, currently unused, and may be used in the future for other purposes such as non-energy related status reports). The following description of the status level subfield 564 and the status reference subfield 566 is for the situation when the status type subfield 562 has a value of zero (0).

The status level subfield 564 may have a first value such as zero (0) for indicating the high-energy level 342, a second value such as one (1) for indicating the alert level 344, or a third value such as two (2) for indicating the low-energy level 346. Value three (3) is reserved.

The status reference subfield 566 may comprise the value of the metric used to enable the AP 102 or the energizer source to interpret the status level subfield 564.

For example, in some embodiments, the status reference subfield 566 may comprise the maximum capacity of the energy storage in mJ with a granularity of 1.6 mJ. In some embodiments, the status reference subfield 566 may comprise the percentage of the remaining energy (with respect to the maximum capacity of the energy storage) with a tolerance of +6.67% or −6.67%.

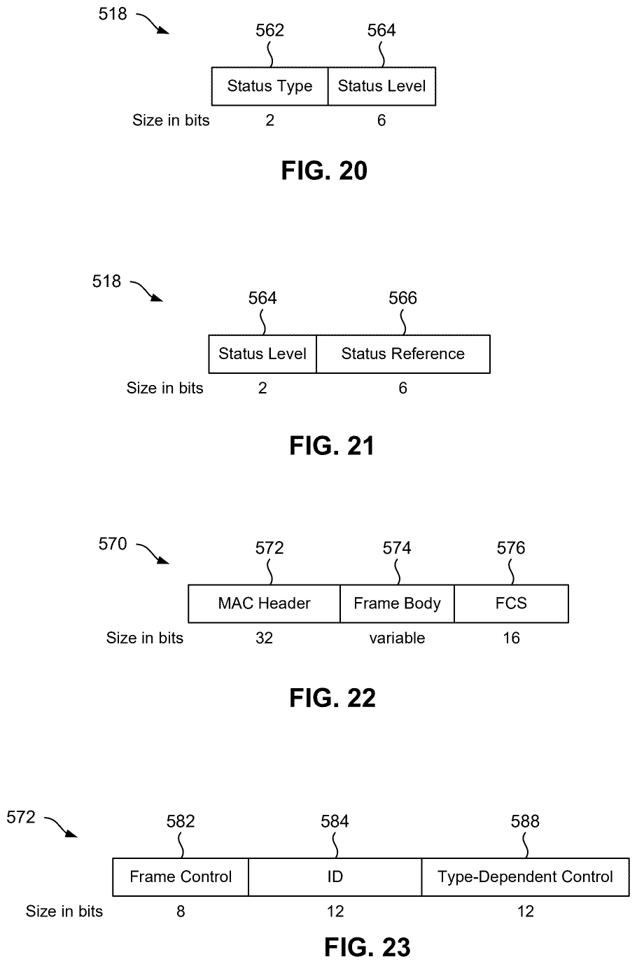

In some embodiments as shown in FIG. 20, the type-dependent control field 518 may comprise a two-bit status type subfield 562 and a six-bit status level subfield 564.

The status type subfield 562 may have a first value such as zero (0) for indicating that the rest of the type-dependent control field 518 indicates the energy or status level of the AMP STA 112 (see below). Values one (1) to three (3) are reserved (which may be used in the future for other purposes such as non-energy related status reports), and when status type subfield 562 has a value of one (1), two (2), or (3), the status level subfield 564 is also reserved (that is, currently unused, and may be used in the future for other purposes such as non-energy related status reports).

When the status type subfield 562 has a value of zero (0), the status level subfield 564 may have a first value such as zero (0) for indicating the high-energy level 342, a second value such as one (1) for indicating the alert level 344, or a third value such as two (2) for indicating the low-energy level 346. Value three (3) is reserved.

Alternatively, when the status type subfield 562 has a value of zero (0), the status level subfield 564 may comprise the percentage of the remaining energy (with respect to the maximum capacity of the energy storage). Yet alternatively, when the status type subfield 562 has a value of zero (0), the status level subfield 564 may comprise a measure of remaining energy stored at the AMP STA 112 (for example, expressed in microjoules).

In some embodiments as shown in FIG. 21, the type-dependent control field 518 may comprise a two-bit status level subfield 564 and a four-bit status reference subfield 566. In other words, the type-dependent control field 518 in these embodiments does not comprise the status type subfield 562.

In these embodiments, the status level subfield 564 may have a first value such as zero (0) for indicating the high-energy level 342, a second value such as one (1) for indicating the alert level 344, or a third value such as two (2) for indicating the low-energy level 346. Value three (3) is reserved.

In these embodiments, the status reference subfield 566 may comprise the value of the metric used to enable the AP 102 or the energizer source to interpret the status level subfield 564.

For example, in some embodiments, the status reference subfield 566 may comprise the maximum capacity of the energy storage in mJ with a granularity of 0.4 mJ. In some embodiments, the status reference subfield 566 may comprise the percentage of the remaining energy (with respect to the maximum capacity of the energy storage) with a tolerance of +1.587% or −1.587%.

In some embodiments, modified WUR frames may be used for signaling of ELSR requesting and/or reporting between the AMP STA 112 and the AP 102.

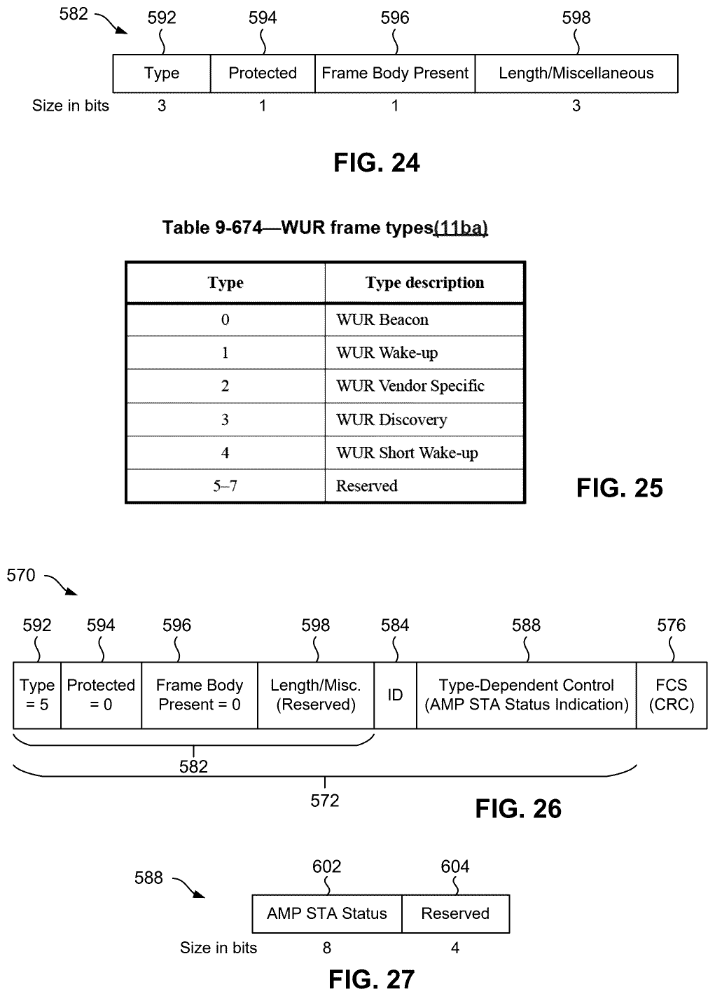

FIG. 22 is a schematic diagram showing the structure of the modified WUR frame 570, which is modified from the conventional WUR frame defined in IEEE 802.11ba (see subsection 9.9 of IEEE P802.11-REVme/D5.0). As shown, the modified WUR frame 570 comprises a 32-bit MAC header 572, a frame body 574 of a variable length, and a 16-bit FCS 576. As shown in FIG. 23, the MAC header 572 comprises an eight-bit frame control field 582, a 12-bit ID field 584, and a 12-bit type-dependent control field 588. As shown in FIG. 24, the frame control field 582 comprises a three-bit type subfield 592, a one-bit protected subfield 594, a one-bit frame body present subfield 596, and a length/miscellaneous subfield 598.

FIG. 25 lists the values and meaning of the type subfield 592, reproduced from Table 9-674 in subsection 9.9 of IEEE P802.11-REVme/D5.0.

In these embodiments, the modified WUR frame 570 is modified from the conventional WUR frame by including a new WUR frame type. Accordingly, the values of the type subfield 592 of the modified WUR frame 570 are shown in Table V below:

TABLE V
VALUES AND MEANINGS OF THE TYPE SUBFIELD
OF THE MODIFIED WUR FRAME

| Type | Type Description |
|---|---|
| 0 | WUR Beacon |
| 1 | WUR Wake-up |
| 2 | WUR Vendor Specific |
| 3 | WUR Discovery |
| 4 | WUR Short Wake-up |
| 5 | AMP |
| 6-7 | Reserved |

Thus, when the type subfield 592 has the value of 1, 2, 3, or 4, the modified WUR frame 570 is used as the conventional WUR frame. When the type subfield 592 has the value of 5, the modified WUR frame 570 is used as an AMP STA status frame, which is automatically sent by the AMP STA 112 to the AP 102, energizer source, or network for reporting ELSR when, for example, the AMP STA increases and pass the high-energy level 342, or decreases and passes the low-energy level 346.

As shown in FIG. 26, the AMP STA status frame 570 may have the following settings:
the type subfield 592 of the frame control field 582 in the MAC header 572 is set to five (5);
the protected subfield 594 of the frame control field 582 in the MAC header 572 is set to zero (0) (reception of protected AMP STA status frame 570 (wherein the protected subfield 594 is set to one (1)) may drain more energy compared to reception of unprotected AMP STA status frames (wherein the protected subfield 594 is set to zero (0)). Therefore, from AMP STA's perspective, it may be preferable that protection of AMP STA status frames is enabled only when required);
the length/miscellaneous subfield 596 of the frame control field 582 in the MAC header 572 is reserved (that is, unused);
the frame body present subfield 596 of the frame control field 582 in the MAC header 572 is set to zero (0), and accordingly, the AMP STA status frame 570 does not include a frame body field 574;
the length/miscellaneous subfield 598 of the frame control field 582 in the MAC header 572 is reserved.
the ID field 584 comprises the ID of the AMP STA 112 (which can be recognized by the AP 102 upon receiving the AMP STA status frame 570 since this ID is assigned to the AMP STA 112 by the AP 102); and
the FCS field 576 comprises the CRC.

The type-dependent control field 588 in the MAC header 572 comprises an indication of the current energy state of the AMP STA 112.

In some embodiments, the type-dependent control field 588 comprises an eight-bit indication subfield 602 as shown in FIG. 27 for indicating the current energy state of the AMP STA 112 (with other bits 604 in the type-dependent control field 588 reserved or unused).

The eight-bit indication subfield 602 may comprise any suitable indication for indicating the current energy state of the AMP STA 112.

For example, in some embodiments, the eight-bit indication subfield 602 has a first value such as zero (0) for indicating the high-energy level 342, a second value such as one (1) for indicating the alert level 344, or a third value such as two (2) for indicating the low-energy level 346. Values 3 to 255 are reserved (which may be defined in the future for other uses such as non-energy related status reports).

In some embodiments, the eight-bit indication subfield 602 comprises a percentage of the remaining energy of the AMP STA 112.

In some embodiments, the eight-bit indication subfield 602 comprises a measurement of the remaining energy of the AMP STA 112, for example, expressed in microjoules.

In some embodiments, the eight-bit indication subfield 602 comprises an indication of a relative energy level being, for example, the difference between the remaining energy of the AMP STA 112 and the low-energy level 346 thereof.

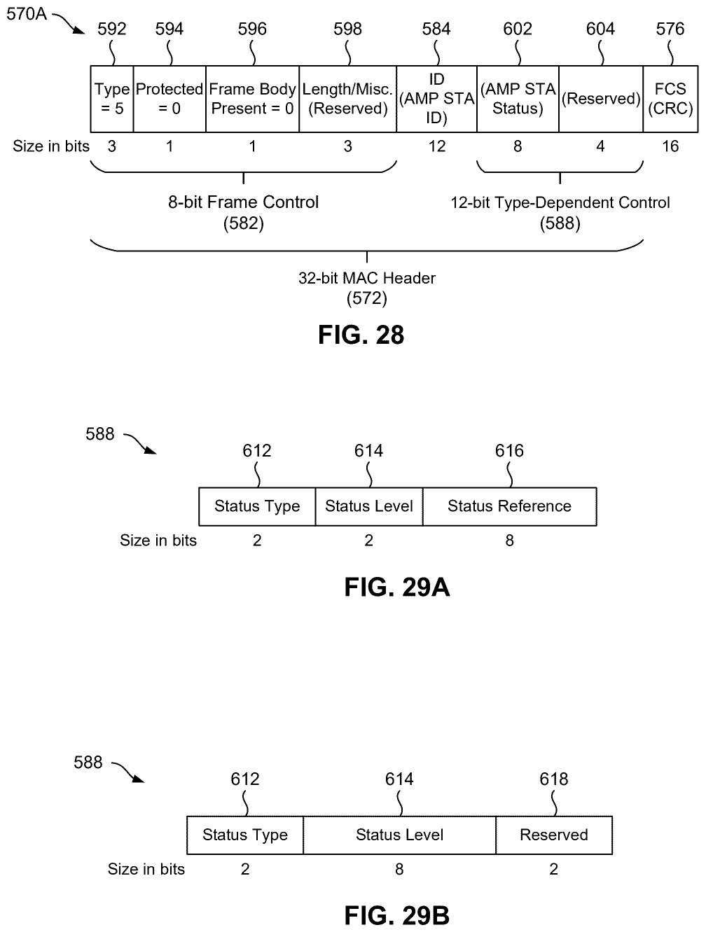

FIG. 28 shows the AMP STA status frame 570A in these embodiments.

In some embodiments as shown in FIG. 29A, the type-dependent control field 588 comprises a two-bit status type subfield 612, a two-bit status level subfield 614, and a four-bit status reference subfield 616.

The status type subfield 612 may have a first value such as zero (0) for indicating that the rest of the type-dependent control field 588 indicates the energy level of the AMP STA 112 (see below). Values one (1) to three (3) are reserved (which may be used in the future for other purposes such as non-energy related status reports), and when status type subfield 612 has a value of one (1), two (2), or (3), the status level subfield 614 and the status reference subfield 616 are also reserved (that is, currently unused, and may be used in the future for other purposes such as non-energy related status reports). The following description of the status level subfield 614 and the status reference subfield 616 is for the situation when the status type subfield 612 has a value of zero (0).

The status level subfield 614 may have a first value such as zero (0) for indicating the high-energy level 342, a second value such as one (1) for indicating the alert level 344, or a third value such as two (2) for indicating the low-energy level 346. Value three (3) is reserved.

The status reference subfield 616 may comprise the value of the metric used to enable the AP 102 or the energizer source to interpret the status level subfield 614.

For example, in some embodiments, the status reference subfield 616 may comprise the maximum capacity of the energy storage. In some embodiments, the status reference subfield 616 may comprise the percentage of the remaining energy (similar to those described above).

Other fields/subfields are the same as those shown in FIG. 28.

In some embodiments as shown in FIG. 29B, the type-dependent control field 588 comprises a two-bit status type subfield 612, an eight-bit status level subfield 614, and a two-bit reserved subfield 618 (that is, currently unused).

The status type subfield 612 may have a first value such as zero (0) for indicating that the rest of the type-dependent control field 588 indicates the energy level of the AMP STA 112 (see below). Values one (1) to three (3) are reserved (which may be used in the future for other purposes such as non-energy related status reports), and when status type subfield 562 has a value of one (1), two (2), or (3), the status level subfield 564 and the status reference subfield 566 are also reserved (that is, currently unused, and may be used in the future for other purposes such as non-energy related status reports). The following description of the status type subfield 562 and the status reference subfield 566 is for the situation when the status type subfield 562 has a value of zero (0).

When the status type subfield 612 has a value of zero (0), the status level subfield 614 may have a first value such as zero (0) for indicating the high-energy level 342, a second value such as one (1) for indicating the alert level 344, or a third value such as two (2) for indicating the low-energy level 346. Other values are reserved.

Alternatively, when the status type subfield 612 has a value of zero (0), the status level subfield 614 may comprise the percentage of the remaining energy (with respect to the maximum capacity of the energy storage). Yet alternatively, when the status type subfield 612 has a value of zero (0), the status level subfield 614 may comprise a measure of remaining energy stored at the AMP STA 112 (for example, expressed in microjoules).

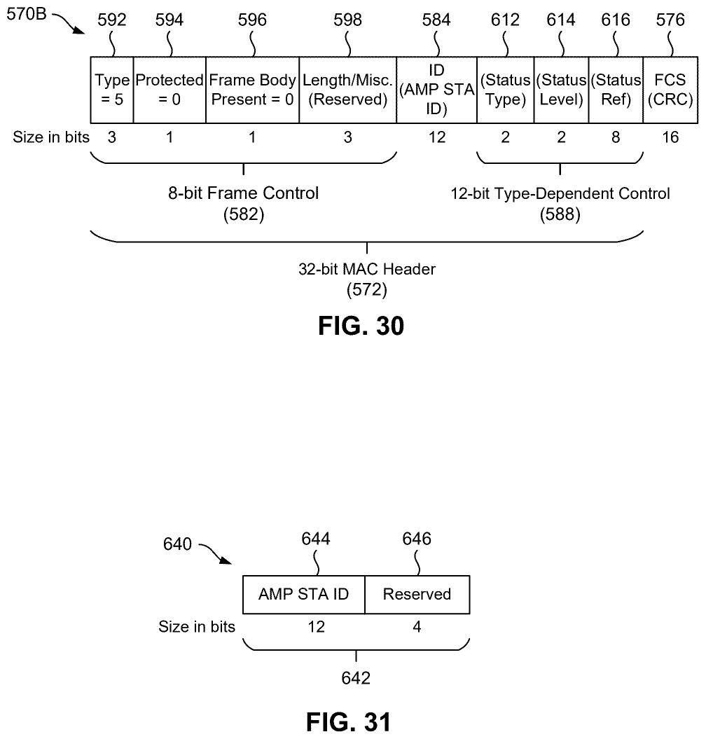

FIG. 30 shows the AMP STA status frame 570B in these embodiments.

With above description, those skilled in the art will appreciate that the AMP STA status frame 570 (being a modified WUR frame) in these embodiments has reduced frame size thereby saving the energy of the AMP STA 112. However, the AMP STA status frame 570 in these embodiments only allow the AMP STA 112 to send its status report to a single AP 102 (or, in some embodiments, to a single STA 112 (also called “non-AP STA”)). In other words, the AMP STA status frame 570 in these embodiments does not support multicast (reporting energy state to multiple APs and/or STAs in the network) and broadcast (reporting energy state to all APs and/or STAs in the network).

In some embodiments, the AMP STA status frame is similar to that shown in FIG. 28 or FIG. 30 with some differences.

More specifically, in these embodiments, the ID field 584 of the frame control field 582 in the MAC header 572 comprises the destination ID, such as the ID of the AP 102, the group ID (for multicasting to a plurality of APs 102 and/or Energy Sources), or the broadcast ID (for multicasting to all devices in the network (including all APs 102)).

In these embodiments, the frame body present subfield 596 of the frame control field 582 in the MAC header 572 is set to one (1), and accordingly, the AMP STA status frame 570 comprises a frame body field 574, which comprises an AMP STA information field. FIG. 31 shows an example of the structure of the AMP STA information field 640 in the frame body field 574 of the AMP STA status frame 570. As shown, the AMP STA information field 640 comprises a two-byte ID field 642, which comprises a 12-bit AMP STA ID 644 and a four-bit reserved (unused) subfield 646.

Moreover, in these embodiments, as the frame body field 504 is present, the length/miscellaneous subfield 598 of the frame control field 582 comprises an indication of the length of the frame body field 574, such as a value L=0, wherein the length of the frame body field 574 is calculated using Equation (1). In other words, the length of the frame body field 574 is two (2) octets.

Other fields/subfields of the AMP STA status frame 570 are the same as that shown in FIG. 28 or FIG. 30.

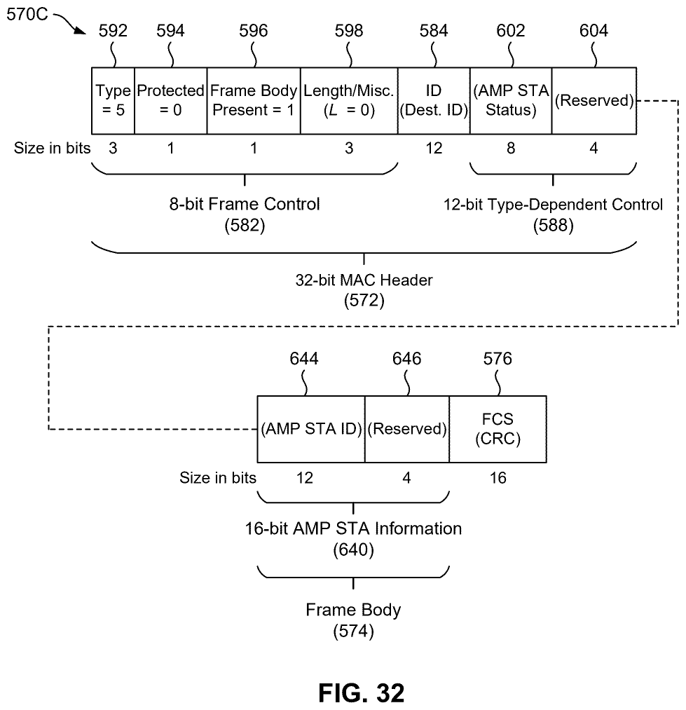

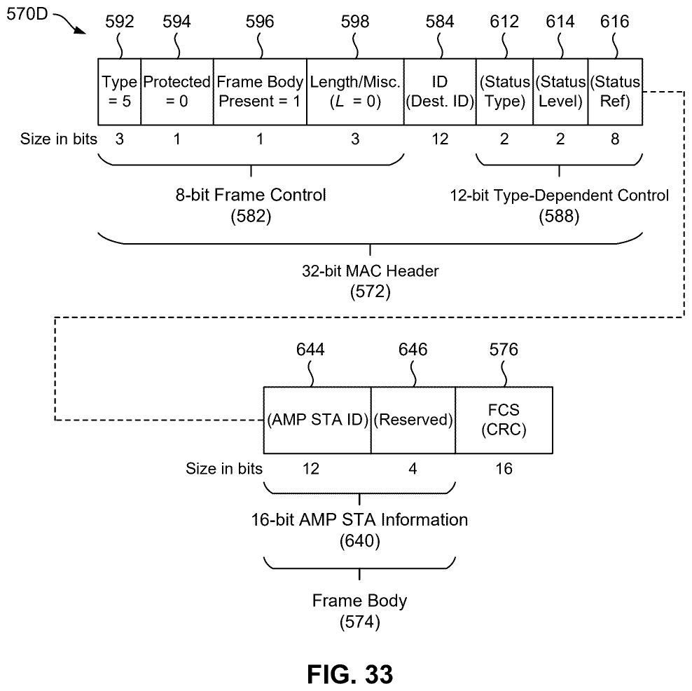

FIGS. 32 and 33 show the structures of the AMP STA status frame 570C and 570D, respectively, in various embodiments, wherein the structure of the AMP STA status frame 570C shown in FIG. 32 is similar to the AMP STA status frame 570A shown in FIG. 28, and structure of the AMP STA status frame 570D shown in FIG. 33 is similar to the AMP STA status frame 570B shown in FIG. 30.

Therefore, by setting the type subfield 592 to five (5), the modified WUR frame 570 is used as the AMP STA status frame 570. In some embodiments, the AMP STA status frame 570 is suitable for sending the energy status of the AMP STA 112 to a single AP 102. In these embodiments, the AMP STA status frame 570 does not comprise a frame body field 574, and the ID field 584 of the MAC header 572 comprises the ID of the AMP STA 112.

In some embodiments, the AMP STA status frame 570 is suitable for sending the energy status of the AMP STA 112 to a single AP 102 (that is, unicast), a plurality of APs (that is, multicast), or all APs (that is, broadcast). In these embodiments, the AMP STA status frame 570 includes the ID of the AMP STA 112 in the frame body field 574, and the ID field 584 of the MAC header 572 comprises the destination ID which may be the ID of the AP 102, a group ID for a plurality of APs, or a broadcast ID for all APs.

As those skilled in the art will appreciate, when AMP STAs 112 have limited energy, sending or receiving ELSR reports can be an energy consumption burden. Therefore, in some embodiments, instead of sending dedicated ELSRs, the AMP STA 112 uses a piggybacking ELSR method for energy-state reporting by embedding its energy-state information into the data packets it transmits (wherein the data packets are for non-ELSR purposes such as for sensor readings or other purposes). Accordingly, the need for additional network traffic to report ELSR is reduced, thereby minimizing energy consumption for reporting on both AP and AMP STA sides.

In some embodiments, the AMP STA 112 may piggyback its energy-state information onto short AMP STA data frames so as to optimize network efficiency.

For example, in the AMP short frame 500, the type subfield 522 may be set to two (2) (see Table IV) to indicate that the AMP short frame 500 is an AMP STA data frame that comprises, in the frame body field 504, data to be sent to the AP 102.

In these embodiments, the protected subfield 524 of the frame control field 512 may be set to one (1) when the transmitted data is important, or set to zero (0) otherwise. The frame body present subfield 526 of the frame control field 512 is set to one (1) to indicate the presence of frame body field 504. The length/miscellaneous subfield 528 of the frame control field 512 comprises an indication of the length of the frame body field 504, for example, in the manner described above.

The type-dependent control field 518 comprises an indication of the energy state of the AMP STA 112, for example, in any of the manners described above.

Other fields/subfields are the same as those of the AMP STA status frame 500B described above.

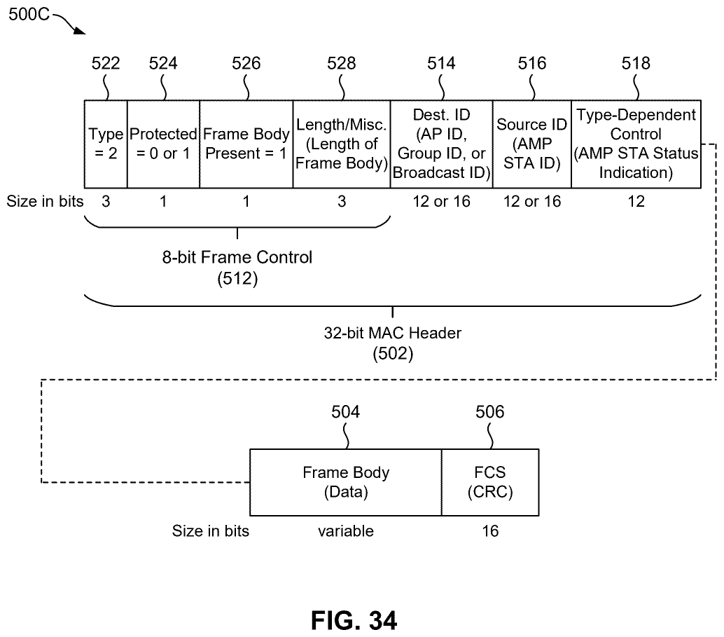

FIG. 34 shows the structure of the AMP STA data frame 500C with above-described settings.

In some embodiments, the modified WUR frame 570 may be used for AMP STA status reporting and data transmission, thereby allowing the AMP STA frame formats to remain simple and short while achieving the desired functionality, which also offers a lightweight solution for frequent, low-overhead communication.

In these embodiments, the modified WUR frame 570 is used as the AMP STA data frame, and the frame body field 574 comprises data to be transmitted to the AP 102.

The protected subfield 594 of the frame control field 582 may be set to one (1) when the transmitted data is important, or set to zero (0) otherwise. The frame body present subfield 596 of the frame control field 582 is set to one (1) to indicate the presence of the frame body field 574 is present in the AMP STA Data Frame. The length/miscellaneous subfield 598 of the frame control field 582 comprises an indication of the length of the frame body field 574, for example, in the manner described above.

The type-dependent control field 588 comprises an indication of the energy state of the AMP STA 112, for example, in any of the manners described above.

Other fields/subfields are the same as those of the AMP STA status frame 570 (such as 570A to 570D) described above.

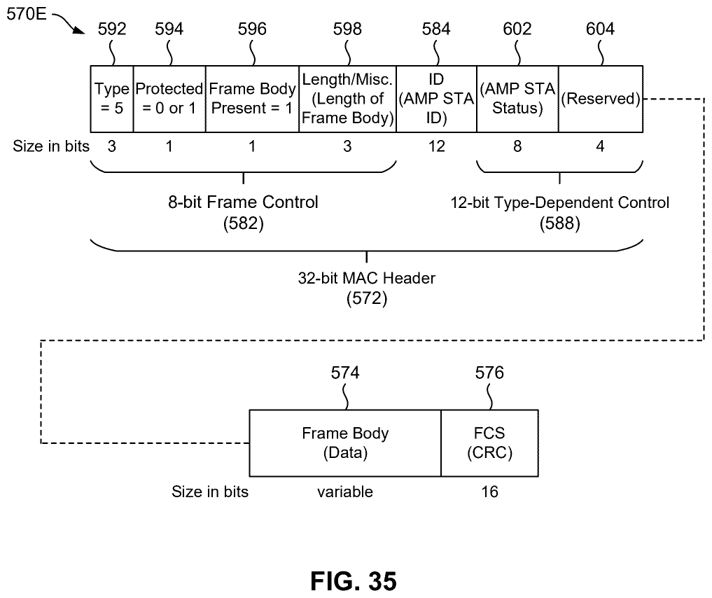

For example, FIG. 35 shows the structure of the AMP STA data frame 570E with above-described settings. The frame body field 574 of the AMP STA data frame 570E comprises data to be transmitted to the AP 102. The 12-bit type-dependent control field 588 of the AMP STA data frame 570E is the same as that of the AMP STA data frame 570A shown in FIG. 28.

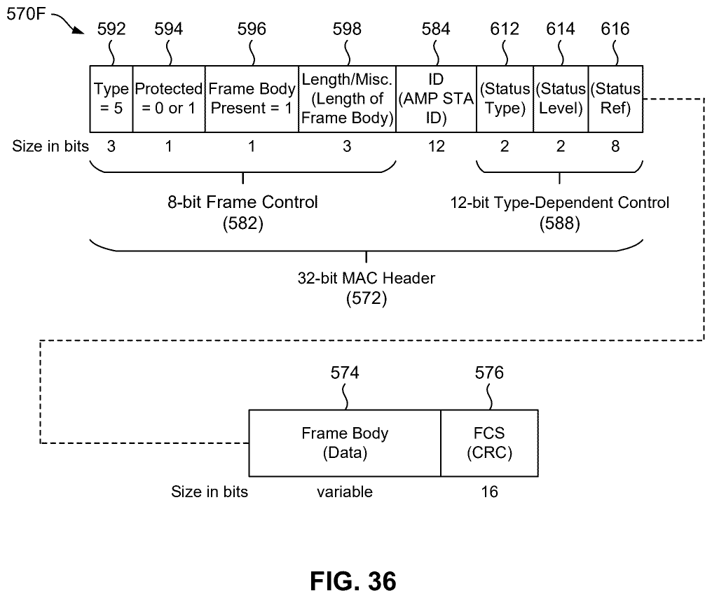

FIG. 36 shows the structure of the AMP STA data frame 570F with above-described settings. The frame body field 574 of the AMP STA data frame 570F comprises data to be transmitted to the AP 102. The 12-bit type-dependent control field 588 of the AMP STA data frame 570F is the same as that of the AMP STA data frame 570B shown in FIG. 30.

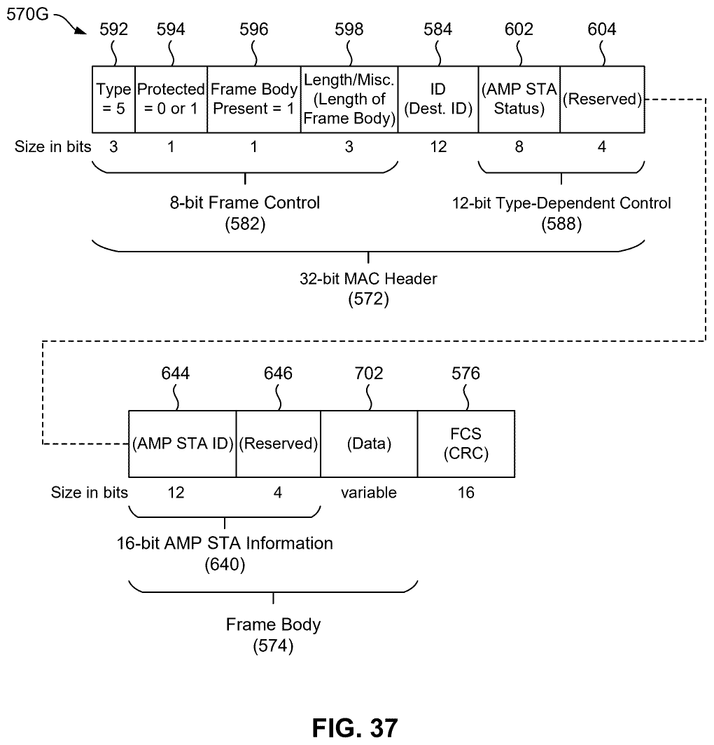

FIG. 37 shows the structure of the AMP STA data frame 570G with above-described settings. The frame body field 574 of the AMP STA data frame 570G comprises a 16-bit AMP STA information field 640 and data to be transmitted to the AP 102. The 16-bit AMP STA information field 640 of the AMP STA data frame 570G is the same as that of the AMP STA data frame 570C shown in FIG. 32. The 12-bit type-dependent control field 588 of the AMP STA data frame 570G is the same as that of the AMP STA data frame 570C shown in FIG. 32.

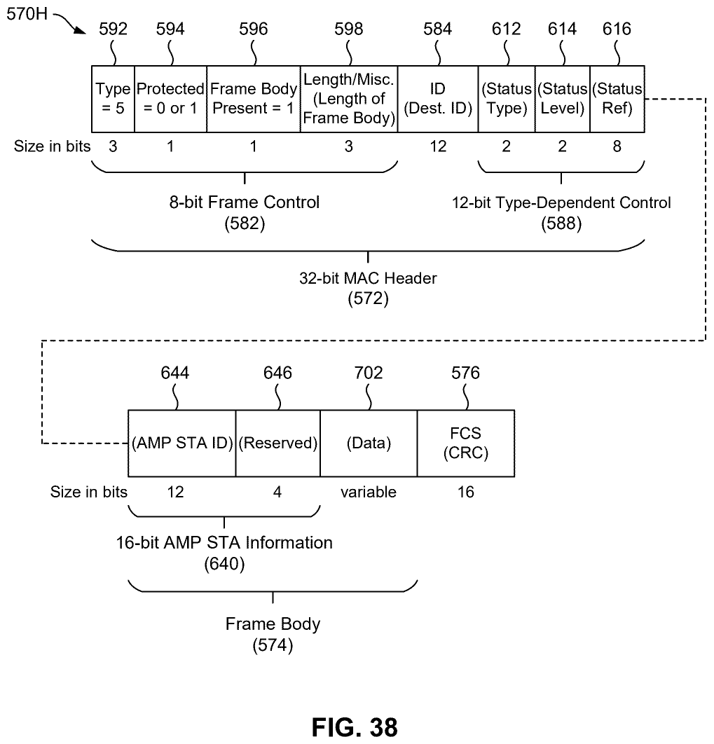

FIG. 38 shows the structure of the AMP STA data frame 570H with above-described settings. The frame body field 574 of the AMP STA data frame 570H comprises a 16-bit AMP STA information field 640 and data to be transmitted to the AP 102. The 16-bit AMP STA information field 640 of the AMP STA data frame 570H is the same as that of the AMP STA data frame 570D shown in FIG. 33. The 12-bit type-dependent control field 588 of the AMP STA data frame 570H is the same as that of the AMP STA data frame 570D shown in FIG. 33.

Although in above embodiments, the AMP STA 112 reports its energy state to the AP 102, in some embodiments, an AMP STA 112 may report its energy state to an energy source and/or another AMP STA 112.

Although in above embodiments, AMP STAs 112 are used as examples for describing the energy-state requesting and/or reporting methods, in some other embodiments, other STAs may also use the energy-state requesting and/or reporting methods disclosed herein.

Although in above embodiments, the energy-state requesting and/or reporting methods are described for WLAN systems, in some other embodiments, the energy-state requesting and/or reporting methods disclosed herein may also be used in other wireless communication systems.

For example, the Third Generation Partnership Project (3GPP) is currently examining AMP devices for inclusion in its 19th release. The study on these AMP IoT devices was first introduced in the 3GPP TR 22.840 V19.0.0 (2023-12) document, entitled “Study on Ambient power-enabled Internet of Things (Release 19)” [3GPP TR 22.840 V19.0.0 (2023-12), “3rd Generation Partnership Project; Technical Specification Group Services and System Aspects; Study on Ambient power-enabled Internet of Things (Release 19)”].

The issue tackled in the WLAN environment as described herein was also introduced in the 3GPP TS 22.369 V1.0.1 (2023-12) document, entitled “Service requirements for ambient power-enabled IoT; Stage 1 (Release 19)” [3GPP TS 22.369 V1.0.1 (2023-12), “3rd Generation Partnership Project; Technical Specification Group TSG SA; Service requirements for ambient power-enabled IoT; Stage 1 (Release 19), section 4.2”].

Those skilled in the art will appreciate that, in some embodiments, the energy-state requesting and/or reporting methods disclosed herein may be used in 3GPP systems and/or incorporated into the 3GPP standard.

Herein, various energy-state requesting and/or reporting methods for AMP STAs to report their energy state to APs 102 or the network are disclosed.

Given that AMP STAs 112 often operate on very limited energy budgets, frequent energy-state reporting can consume valuable energy, potentially leading to fast energy depletion. On the other hand, the conventional AP lacks knowledge about an AMP STA's current energy level. Such a situation can lead to inefficient resource utilization.

To address this issue, the methods disclosed herein may be used by the AMP STAs 112 and APs 102 to report the AMP STAs's energy states to the APs 102.

In some embodiments, the AMP STA 112 may report its energy state when one or more conditions are met. Accordingly, the energy spent on energy-state reporting is reduced.

For example, the AMP STA 112 may report its energy state when one or more events occur, such as when the energy of the AMP STA 112 (such as the energy stored in the AMP STA 112 or the energy of the AMP STA 112 that is available for use in wireless communication) changes and passes one of one or more energy levels (for example, increasing from smaller than an energy level to greater than the energy level, or decreasing from greater than an energy level to smaller than the energy level). Alternatively or in addition, the AMP STA 112 may report its energy state in response to an AP's request.

In some embodiments, the AMP STA 112 may include its energy state and non-energy-state data in the same frame for transmitting to the AP 102, thereby eliminating the need for separate energy-state reporting and further reducing energy expenditure.

The methods disclosed herein may use any suitable frame structure.

For example, in some embodiments, AMP action frames may be used, which offer targeted functionality for particular AMP tasks such as verifying the aliveness of the AMP STA 112 and reporting its energy levels.

In some embodiments, AMP short frames may be used, which provide a lightweight solution for frequent, low-overhead communication.

In some embodiments, modified WUR frames may be used for AMP STA energy-state reporting, allowing energy-state reporting using simple and short frames.

In some embodiments, the frames used for energy-state requesting and/or reporting may also be used for transmitting non-energy-state related data.

The methods disclosed herein may use any suitable indication for indicating the energy-state of an AMP STA 112.

For example, in some embodiments, the methods disclosed herein may use an indication of a percentage of the remaining energy of the AMP STA 112 (with respect to a reference energy level such as the full energy level thereof), a measurement of the remaining energy of the AMP STA 112, a relative energy level (such as the difference between the remaining energy of the AMP STA 112 and the high-energy level threshold 342 thereof, or the difference between the remaining energy of the AMP STA 112 and the low-energy level threshold 346 thereof), and/or the like.

In some embodiments, the methods disclosed herein may use an indication comprising a status level 422 and a status reference 424. The reported status level 422 may be one of one or more levels such as a high-energy level 342, an alert level 344, and a low-energy level 346. The status reference field 424 comprises the value of the metric used to enable the AP 102 or the energizer source who receives the energy-state report to interpret the status level 422.

In some embodiments, the methods disclosed herein may use an indication comprising a status type subfield 562, a status level subfield 564, and a status reference subfield 566.

By utilizing the methods disclosed herein, the AP 102 may effectively schedule data transmissions to AMP STAs 112, avoiding communication initiation with AMP STAs 112 that lack sufficient power, which leads to significant improvements in network efficiency and a reduction in wasted resources.

The methods disclosed herein address several critical limitations of current communication protocols, and offer significant benefits for both the network and the AMP STAs 112.

With the methods disclosed herein, the AP 102 receives updates on the STA's energy state, which enables the AP 102 to make informed decisions about data transmissions based on the reported energy state of the STA, thereby leading to:
reducing wasted resources: The AP 102 avoids transmitting data to AMP STAs 112 with insufficient energy, thereby preventing wasted network resources and potential data loss.
optimizing critical data scheduling: The AP 102 may schedule critical data transmissions strategically, for example, only when the AMP STA 112 has enough energy to process them.
reducing retransmissions: Knowing the AMP STA's energy state helps the AP 102 to avoid failed transmissions, thereby reducing the need for retransmissions and improving overall network performance.

In some embodiments, the method disclosed herein uses an event-based method to trigger STA's energy-state reporting such that the ELSR is only transmitted under one or more conditions (such as at high-energy level, critically low-energy threshold, or upon AP's request), which minimizes energy that may otherwise waste on frequent reporting, and thereby gives rise to reduced energy consumption.

In some embodiments, the methods disclosed herein enables the STA 112 to transmit the energy-state information with data packets, which eliminates the need for separate transmissions for energy-state reporting, thereby leading to reduced overhead and energy consumption.

Thus, the methods disclosed herein give rise to a more efficient communication ecosystem for AMP devices 112. The network operates with improved resource allocation and scheduling, while AMP STAs 112 conserve their limited energy resources by avoiding unnecessary reporting.

This translates to a more robust and sustainable network environment for AMP devices 112.

### C. Acronyms, Abbreviations, and Definition of Some Terms

| Full Name | Acronym/Abbreviation/Initialism |
|---|---|
| Ambient Power | AMP |
| Access Point | AP |
| Downlink | DL |
| Energy-Level Status Report | ELSR |
| Internet-of-Things | IoT |
| Reception | RX |
| Service Period | SP |
| Station | STA |
| Transmission | TX |
| Ultra-High Reliability | UHR |
| Uplink | UL |
| Wake-up Radio | WUR |
| Wireless LAN | WLAN |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
obtaining information of an energy state of a first device; and
sending to a second device an indication for indicating the information of the energy state.

2. The communication method of claim 1, wherein said sending to the second device the indication comprises:
sending to the second device a first frame, the first frame comprising the indication, or comprising the indication and non-energy-state-related data.

3. The communication method of claim 2, wherein the first frame comprises:
a first media access control (MAC) header;
a first category field indicating that the first frame is related to the information of the energy state;
a first action field indicating reporting of the information of the energy state; and
the indication.

4. The communication method of claim 2, wherein the first frame comprises a first MAC header and a first frame check sequence (FCS);
wherein the first MAC header comprises a first frame control field, a first destination identifier (ID) field, a first source ID field, and a first type-dependent control field;
wherein the first frame control field comprises a first type subfield indicating reporting of the information of the energy state, and a first frame-body-present subfield indicating non-presence of a first frame body;
wherein the first destination ID field indicating one or more devices including the second device;
wherein the first source ID field indicating the first device; and
wherein the first type-dependent control field comprises the indication.

5. The communication method of claim 2, wherein the first frame comprises a first MAC header, a first frame body, and a first FCS;
wherein the first MAC header comprises a first frame control field, a first destination identifier (ID) field, a first source ID field, and a first type-dependent control field;
wherein the first frame control field comprises a first type subfield indicating reporting of the information of the energy state, and a first frame-body-present subfield indicating presence of the first frame body;
wherein the first destination ID field indicating one or more devices including the second device;
wherein the first source ID field indicating the first device;
wherein the first type-dependent control field comprises the indication; and
wherein the frame body comprises non-energy-state-related data.

6. The communication method of claim 2, wherein the first frame is a wake-up radio (WUR) frame, and comprises a first MAC header and a first FCS;
wherein the first MAC header comprises a first frame control field, a first ID field, and a first type-dependent control field;
wherein the first frame control field comprises a first type subfield indicating reporting of the information of the energy state, and a first frame-body-present subfield indicating non-presence of a first frame body;
wherein the first ID field indicating the first device; and
wherein the first type-dependent control field comprises the indication.

7. The communication method of claim 2, wherein the first frame is a WUR frame, and comprises a first MAC header, a first frame body, and a first FCS;
wherein the first MAC header comprises a first frame control field, a first ID field, and a first type-dependent control field;
wherein the first frame control field comprises a first type subfield indicating reporting of the information of the energy state, and a first frame-body-present subfield indicating presence of the first frame body;
wherein the first ID field indicating one or more devices including the second device;
wherein the first type-dependent control field comprises the indication; and
wherein the first frame body comprises an ID of the first device.

8. An apparatus comprising:
one or more non-transitory computer-readable storage devices comprising computer-executable instructions; and
one or more processors functionally coupled to the one or more non-transitory computer-readable storage devices;
wherein the instructions, when executed, cause the one or more processors to perform actions comprising:
obtaining information of an energy state of a first device, and
sending to a second device an indication for indicating the information of the energy state.

9. One or more non-transitory computer-readable storage devices comprising computer-executable instructions, wherein the instructions, when executed, cause one or more processors to perform actions comprising:
obtaining information of an energy state of a first device; and
sending to a second device an indication for indicating the information of the energy state.

10. The one or more non-transitory computer-readable storage devices of claim 9, wherein said sending to the second device the indication comprises:
sending to the second device the indication when one or more conditions are met, when one or more events occur, or a combination thereof.

11. The one or more non-transitory computer-readable storage devices of claim 9, wherein said sending to the second device the indication comprises:
sending to the second device the indication when one of a plurality of events occurs; and
wherein the plurality of events comprise:
an energy of the first device having increased and passed a first energy-level threshold, and
the energy of the first device having decreased and passed a second energy-level threshold, the second energy-level threshold being smaller than the first energy-level threshold; and
receiving from the second device a request for reporting the information of the energy state.

12. The one or more non-transitory computer-readable storage devices of claim 9, wherein said sending to the second device the indication comprises:
sending to the second device a first frame, the first frame comprising the indication, or comprising the indication and non-energy-state-related data.

13. The one or more non-transitory computer-readable storage devices of claim 12, wherein the first frame comprises:
a first media access control (MAC) header;
a first category field indicating that the first frame is related to the information of the energy state;
a first action field indicating reporting of the information of the energy state; and
the indication.

14. The one or more non-transitory computer-readable storage devices of claim 12, wherein the first frame comprises a first MAC header and a first frame check sequence (FCS);
wherein the first MAC header comprises a first frame control field, a first destination identifier (ID) field, a first source ID field, and a first type-dependent control field;
wherein the first frame control field comprises a first type subfield indicating reporting of the information of the energy state, and a first frame-body-present subfield indicating non-presence of a first frame body;
wherein the first destination ID field indicating one or more devices including the second device;
wherein the first source ID field indicating the first device; and
wherein the first type-dependent control field comprises the indication.

15. The one or more non-transitory computer-readable storage devices of claim 12, wherein the first frame comprises a first MAC header, a first frame body, and a first FCS;
wherein the first MAC header comprises a first frame control field, a first destination identifier (ID) field, a first source ID field, and a first type-dependent control field;
wherein the first frame control field comprises a first type subfield indicating reporting of the information of the energy state, and a first frame-body-present subfield indicating presence of the first frame body;
wherein the first destination ID field indicating one or more devices including the second device;
wherein the first source ID field indicating the first device;
wherein the first type-dependent control field comprises the indication; and
wherein the frame body comprises non-energy-state-related data.

16. The one or more non-transitory computer-readable storage devices of claim 12, wherein the first frame is a wake-up radio (WUR) frame, and comprises a first MAC header and a first FCS;
wherein the first MAC header comprises a first frame control field, a first ID field, and a first type-dependent control field;
wherein the first frame control field comprises a first type subfield indicating reporting of the information of the energy state, and a first frame-body-present subfield indicating non-presence of a first frame body;
wherein the first ID field indicating the first device; and
wherein the first type-dependent control field comprises the indication.

17. The one or more non-transitory computer-readable storage devices of claim 12, wherein the first frame is a WUR frame, and comprises a first MAC header, a first frame body, and a first FCS;
wherein the first MAC header comprises a first frame control field, a first ID field, and a first type-dependent control field;
wherein the first frame control field comprises a first type subfield indicating reporting of the information of the energy state, and a first frame-body-present subfield indicating presence of the first frame body;
wherein the first ID field indicating one or more devices including the second device;
wherein the first type-dependent control field comprises the indication; and
wherein the first frame body comprises an ID of the first device.

18. The one or more non-transitory computer-readable storage devices of claim 9, wherein the indication is for indicating a high-energy level of the first device, an alert level of the first device, or a low-energy level of the first device;
wherein the indication comprises a percentage of remaining energy of the first device with respect to a first reference energy level;
wherein the indication comprises a measurement of the remaining energy of the first device; or
wherein the indication comprises a relative energy level with respect to a second reference energy level.

19. The one or more non-transitory computer-readable storage devices of claim 9, wherein the indication comprises a status level and a status reference;
wherein the status level is for indicating a high-energy level of the first device, an alert level of the first device, or a low-energy level of the first device; and
wherein the status reference comprises a metric used for interpreting the status level.

20. The one or more non-transitory computer-readable storage devices of claim 19, wherein the indication further comprises a status type having a value for indicating that the indication is for indicating the status level.
